(19) United States
(12) Patent Application Publication
(10) Pub. No.: US 2026/0138128 A1
(43) Pub. Date: May 21, 2026

(54) SEGMENTED FLUIDIC MIXING

(71) Applicant: LumiraDx UK Ltd., London (GB)

(72) Inventors: Aman Murtaza Khan, Bedford (GB); Badr Aman Khan, Bedford (GB); Usman Ali Khan, Bedford (GB); Andrew Peter Phelan, Cheltenham (GB); Dave Scott, Oxford (GB)

(21) Appl. No.: 19/120,175

(22) PCT Filed: Oct. 10, 2023
(86) PCT No.: PCT/GB2023/052623

§ 371 Date: Apr. 10, 2025

Related U.S. Application Data
(60) Provisional application No. 63/414,667, filed on Oct. 10, 2022.
(60) Provisional application No. 63/441,114, filed on Jan. 25, 2023.

(51) Int. Cl. B01L 3/00; B01F 31/65; B01F 33/302; B01F 101/23

(52) U.S. Cl. CPC B01L 3/5027; B01F 31/65; B01F 33/302; B01F 2101/23; B01F 2215/0431; B01L 2200/16; B01L 2300/0887; B01L 2300/14; B01L 2400/0406

(57) ABSTRACT

Mixing a liquid sample and at least one reagent in microchannel of a microfluidic device includes preparing a segment of the liquid sample in contact with the reagent(s) within the microchannel. The liquid segment has a volume of 2 μL or less and defines a proximal gas-liquid interface and a distal liquid-gas interface. The gas of the proximal gas-liquid interface is in gaseous communication with a distal liquid-gas interface of another amount of liquid disposed proximally to the liquid segment within the microchannel of the microfluidic channel. The gas of the distal liquid-gas interface is disposed distally to the liquid segment within the microfluidic channel. With the liquid of the liquid segment in contact with the reagent(s) within the microchannel, the gas of the distal liquid-gas interface and/or the gas of the proximal gas-liquid interface is/are oscillated at an acoustic frequency to induce mixing of the liquid and the reagent(s).

### RELATED APPLICATIONS

This application claims the benefit of and priority to U.S. Patent Application No. 63/414,667, titled “Segmented Fluidic Mixing”, and filed 10 Oct. 2022, and U.S. Patent Application No. 63/441,114, titled “Segmented Fluidic Mixing”, and filed 25 Jan. 2023, each of which is incorporated herein by reference in its entirety. This application is further related to international patent application No. PCT/GB2023/050189, titled “Microfluidic Devices”, and filed Jan. 27, 2023 (the “'189 Application”); international patent application no. PCT/US2021/013325, titled “Fluid Control in Microfluidic Devices”, and filed Jan. 13, 2021 (the “'325 Application”);, each of which is incorporated herein by reference in its entirety.

### FIELD OF THE INVENTION

The present invention relates to methods and systems for mixing liquids and reagents within microfluidic channels.

### BACKGROUND

A microfluidic device may be used to combine a liquid sample with a reagent disposed within a microchannel of the device to perform an assay for a target present in the liquid sample. Mixing materials, e.g., a liquid sample and a reagent, within the microchannels of microfluidic devices poses challenges not often faced in macroscopic volumes. For example, efficient mixing can be difficult to achieve within microchannels in which slow diffusive processes may dominate.

### SUMMARY OF THE INVENTION

In embodiments, a method includes preparing a liquid segment in contact with and/or containing at least one reagent within a microchannel of a microfluidic device, wherein (i) the liquid segment defines a proximal gas-liquid interface and a distal liquid-gas interface, (ii) the gas of the proximal gas-liquid interface is a separating gas disposed between the liquid segment and a liquid-gas interface of an amount of liquid disposed within the microchannel proximally to the liquid segment, and (iii) the gas of the distal liquid-gas interface is a distal gas disposed within the microfluidic channel distally to the liquid segment. The method may further include mixing the liquid of the liquid segment with the reagent(s) by oscillating the pressure of the distal gas and/or the pressure of the separating gas thereby forming a first mixture.

The oscillation may consist of oscillating the pressure of the distal gas. The oscillation may consist of oscillating the pressure of the separating gas. Alternatively, the oscillating may include simultaneously oscillating the pressures of both the distal gas and the separating gas. wherein the step of oscillating comprises oscillating the pressure of the distal gas and the separating gas in phase with one another. The pressure of the distal gas and the separating gas may be oscillated out of phase with one another or in phase with one another. The oscillating the pressure of the distal gas and the separating gas may be performed at the same frequency and/or at different frequencies during at least a portion of the oscillating.

The oscillating of the pressure of the pressure of the distal gas and/or separating gas may be performed at a frequency of about 2000 Hz or less, about 1500 Hz or less, about 1250 Hz or less, about 1000 Hz or less, about 900 Hz or less, or about 800 Hz or less. The oscillating of the pressure of the pressure of the distal gas and/or separating gas may be performed at a frequency of at least about 250 Hz, at least about 500 Hz, or at least about 600 Hz.

The oscillating the pressure of the distal gas may be performed by oscillating the internal spacing between a first inner wall of a region of the microchannel occupied by the distal gas and a second inner wall of the region. The region may be a chamber in gaseous communication with the distal liquid-gas interface within the microchannel. The oscillated region may be spaced apart along the microchannel from the distal liquid-gas interface of the liquid segment. The oscillating the pressure of the separating gas may be performed by oscillating the internal spacing between a first inner wall of a region of the microchannel and a second inner wall of the region occupied by the separating gas. The region may be a chamber in gaseous communication with the proximal gas-liquid interface within the microchannel. The oscillated region may be spaced apart along the microchannel from the proximal gas-liquid interface of the liquid segment. The separating gas and the distal gas are spaced apart and isolated from one another by the liquid segment.

During the step of oscillating, the distal liquid-gas interface and/or the proximal gas-liquid interface of the liquid segment may occupy a location of the channel having a cross sectional area of at least about 0.01 mm², at least about 0.02 mm², at least about 0.03 mm², at least about 0.04 mm², at least about 0.05 mm², at least about 0.06 mm², or at least about 0.07 mm². During the step of oscillating, the distal liquid-gas interface and/or the proximal gas-liquid interface may occupy a location of the channel having a cross sectional area of about 0.15 mm² or less, about 0.125 mm² or less, about 0.1 mm² or less, about 0.09 mm² or less, or about 0.08 mm² or less. During the step of oscillating, the distal liquid-gas interface and/or the proximal gas-liquid interface may occupy a location of the channel having a cross sectional area of about 0.01 mm² to about 0.15mm², for example, about 0.01 mm² to about 0.125 mm², about 0.01 mm² to about 0.1 mm², about 0.01 mm² to about 0.09 mm², about 0.01 mm² to about 0.08 mm², about 0.04 mm² to about 0.15 mm², for example, about 0.04 mm² to about 0.125 mm², about 0.04 mm² to about 0.1 mm², about 0.04 mm² to about 0.09 mm², about 0.04 mm² to about 0.08 mm², about 0.07 mm² to about 0.15 mm², for example, about 0.07 mm² to about 0.125 mm², about 0.07 mm² to about 0.1 mm², about 0.07 mm² to about 0.09 mm², or about 0.07 mm² to about 0.08mm².

During the step of oscillating, the liquid segment may have a volume of at least about 0.2 μL or more, at least about 0.3 μL or more, at least about 0.4 μL or more, or at least about 0.5 μL or more. During the step of oscillating, the liquid segment may have a volume of about 2 μL or less, about 1.75 μL or less, about 1.5 μL or less, about 1.25 L or less, about 1 μL or less, about 0.75 L or less, or about 0.5 μL or less. During the step of oscillating, the liquid segment may have a volume of about 0.2 μL to about 2 μL, about 0.2 μL to about 1.75 μL, about 0.2 L to about 1.5 μL, about 0.2 μL to about 1.25 μL, about 0.2 μL to about 1 μL, about 0.2 μL to about 0.75 μL, about 0.2 μL to about 0.5 μL, about 0.3 μL to about 2 μL, about 0.3 μL to about 1.75 μL, about 0.3 μL to about 1.5 μL, about 0.3 μL to about 1.25 μL, about 0.3 μL to about 1 μL, about 0.3 μL to about 0.75 μL, about 0.3 μL to about 0.5 L, about 0.4 μL to about 2 μL, about 0.4 μL to about 1.75 μL, about 0.4 μL to about 1.5 μL, about 0.4 μL to about 1.25 μL, about 0.4 μL to about 1 μL, about 0.4 μL to about 0.75 μL, about 0.4 μL to about 0.5 μL, about 0.5 μL to about 2 μL, about 0.5 μL to about 1.75 L, about 0.5 μL to about 1.5 μL, about 0.5 μL to about 1.25 μL, about 0.5 μL to about 1 μL, about 0.5 μL to about 0.75 μL, or about 0.5 μL.

The method may include, prior to the step of preparing the liquid segment, introducing a volume of a liquid into the microchannel of the microfluidic device and separating the liquid segment from a remaining portion of the introduced liquid. The remaining portion of the introduced liquid is then the amount of liquid disposed within the microchannel proximally to the liquid segment. The step of separating the liquid segment may be performed by introducing a separating gas into the microchannel at a location occupied by the volume of introduced liquid.

The step of introducing the volume of liquid may include applying the liquid to an application zone of the microfluidic device. The introducing may further include moving the introduced liquid, e.g., by capillary action, along the microchannel until the distal sample liquid-gas interface of the introduced liquid contacts a capillary stop within the microchannel. The step of moving the liquid by capillary action may include moving the liquid along the microchannel until the distal sample liquid-gas interface reaches and moves beyond a location at which the separating gas will be introduced. The capillary stop may include one or more vents providing gaseous communication between the microfluidic channel and a volume of gas disposed externally to the microfluidic channel. The volume of gas may be the gas of the ambient air surrounding the microfluidic device. The capillary stop may alternatively or additionally include one or more hydrophobic features within the microfluidic channel such as a hydrophobic layer than may be in the form of a hydrophobic strip extending across at least some or all of the channel width.

The application zone of the microfluidic device may include a porous membrane configured to separate a liquid of a particulate-containing liquid from particulates thereof. For example, the particulate-containing liquid may be whole blood, the separated liquid may be plasma separated from red blood cells of the whole blood, and the microfluidic device may be configured to facilitate the detection of at least one target. The at least one target may include any target suitable for determination in a plasma sample such as HbA1c or a cardiac marker such as troponin I or troponin C. Particulates are retained on an upper surface of and/or within the porous membrane. The device may prepare a segment of liquid from the liquid separated from the particulate-containing liquid.

In embodiments, the method includes contacting the volume of introduced liquid with at least one reagent disposed in the microchannel prior to the step of separating the liquid segment from the remaining portion of the introduced liquid. For example, the step of introducing may include moving the introduced liquid, e.g., by capillary action, along the microchannel until the distal liquid-gas interface of the introduced liquid passes beyond the at least one reagent disposed in the microchannel and then stopping the movement of the introduced liquid. The stopping may be performed by, e.g., using a capillary stop and/or ceasing a motive force acting on the introduced liquid. The motive force may be, e.g., a decreased pressure of the gas of the distal liquid-gas interface of the introduced liquid. Subsequently, the liquid segment is separated from the remaining portion of the introduced liquid to prepare the liquid segment in contact with the at least one reagent within a microchannel. The liquid segment includes all of the introduced liquid that is in contact with and/or contains the at least one reagent. The step of mixing the liquid of the liquid segment with the reagent(s) by oscillating the pressure of the distal gas and/or the pressure of the separating gas is then performed on the liquid segment. The liquid segment in contact with and/or containing the at least one reagent may then be moved along the microchannel until the liquid of the liquid segment is in contact with at least one additional reagent. The step of mixing the liquid of the liquid segment with the reagent(s) by oscillating the pressure of the distal gas and/or the pressure of the separating gas may then be performed on the liquid segment in contact with and/or containing the at least one additional reagent.

In embodiments, the method includes first preparing a liquid segment that is not in contact with and does not contain the at least one reagent and then contacting the one or more reagents with the liquid segment to prepare the liquid segment in contact with the at least one reagent within a microchannel. For example, the step of introducing may include moving the introduced liquid, e.g., by capillary action, along the microchannel and then stopping the movement of the introduced liquid before the distal liquid-gas interface of the introduced liquid contacts one or more reagents disposed in the microchannel. The stopping may be performed by, e.g., using a capillary stop and/or ceasing a motive force acting on the introduced liquid. The motive force may be, e.g., a decreased pressure of the gas of the distal liquid-gas interface of the introduced liquid. The liquid segment is then separated from the remaining portion of the introduced liquid and moved along the microchannel until the liquid of the liquid segment contacts the one or more reagents. The liquid segment includes all of the introduced liquid that is in contact with or contains the at least one reagent. The step of mixing the liquid of the liquid segment with the reagent(s) by oscillating the pressure of the distal gas and/or the pressure of the separating gas is then performed on the liquid segment. The liquid segment in contact with and/or containing the at least one reagent may be moved along the microchannel until the liquid of the liquid segment is in contact with at least one additional reagent. The step of mixing the liquid of the liquid segment with the reagent(s) by oscillating the pressure of the distal gas and/or the pressure of the separating gas may then be performed on the liquid segment in contact with and/or containing the at least one additional reagent.

In embodiments, after introducing the volume of liquid into the microfluidic channel, the distal gas occupies a chamber of the microfluidic device that is isolated with respect to an ambient gas surrounding the microfluidic device. The ambient gas may be air. Prior to introducing the volume of liquid into the microfluidic channel, the microfluidic channel, and optionally one or more vents, provides the only route for gaseous communication between the distal gas and the exterior of the microfluidic device. After introducing the volume of liquid into the microfluidic channel, the distal gas may occupy a chamber of the microfluidic device that is isolated with respect to an ambient gas surrounding the microfluidic device. For example, the presence of the introduced liquid may obstruct the passage of the distal gas or the ambient gas along the microchannel and, if present, through the one or more vents.

In embodiments, a method includes separating a segment of liquid (which may also be referred to as a liquid segment) from a total amount of liquid disposed within a microchannel of a microfluidic device. The separating of the segment of liquid includes introducing a separating gas into the microchannel from a gas introduction opening disposed at a location of the microchannel occupied by liquid of the total amount of liquid (i.e., after the liquid has been introduced to the microchannel). Introduction of the separating gas into the microchannel (e.g., via the gas introduction opening) forms an asymmetrical gas bubble that separates the segment of liquid from a remaining liquid of the total amount of liquid. The gas of the asymmetric gas bubble and the liquid of the segment of liquid form a first gas-liquid interface having a radius of curvature r1. The gas of the asymmetric gas bubble and the remaining liquid of the total amount of liquid form a second gas-liquid interface having a radius of curvature r2. The asymmetric gas bubble is asymmetric because the radius of curvature r1 is different from the radius of curvature r2 (e.g., hence the two ends of the asymmetric gas bubble interfacing the corresponding liquid are not symmetrical with each other). The volume of the liquid segment, after forming the asymmetric gas bubble, may have the same volume as for the volume of the liquid segment described herein (e.g., as described in the above method of preparing a liquid segment). In embodiments, the volume of the liquid segment is between about 0.75 μL and about 4 μL, e.g., between about 1.5 μL and about 3 μL, e.g., about 2 μL. The volume of the asymmetric gas bubble disposed within the microchannel between the first and second gas-liquid interfaces may be, e.g., between about 200 nL and about 750 nL, e.g., about 350 nL.

In embodiments, r2>r1. For example, a ratio r2/r1 may be at least about 1.25, e.g., between about 1.5 and 3.5, e.g., about 2. A ratio of the greater of the width (w2) and height (h2) of the microchannel at the location of the second gas-liquid interface to the greater of the width (w1) and height (h1) of the microchannel at the location of the first gas-liquid interface may be about the same as the ratio r2/r1, i.e., w2/w1 or h2/h1 may be about the same as r2/r1. Alternatively, or in combination, a ratio of the cross sectional area (A2) of the separation channel (e.g., location of the asymmetric bubble within the microchannel) at the location of the second gas-liquid interface to the cross-sectional area (A1) of the separation channel at the location of the first gas-liquid interface may be about the same as the ratio r2/r1, i.e., A2/A1 may be about the same as r2/r1.

In embodiments, the microfluidic device includes a liquid application zone, e.g., a sample application zone, through which the total amount of liquid is introduced into the microfluidic channel. The first gas-liquid interface may be disposed distally to the second gas-liquid interface and the liquid application zone along the microfluidic channel.

In embodiments, a distance along the microchannel between the first gas-liquid interface and the gas-introduction opening is a distance d1, a distance along the microchannel between the second gas-liquid interface and the gas-introduction opening is a distance d2, and a ratio d2/d1 is at least about 2.25, e.g., is between about 2.25 and 10, e.g., about 4.5. For example, d1 may be between about 250 μm and 1000 μm, e.g., about 500 μm and d2 may be between about 1000 μm and about 2750 μm, e.g., about 2000 μm.

The liquid introduced to the microfluidic device, the remaining volume of liquid, and/or the liquid segment may include any liquid to be mixed with one or more reagents. Exemplary suitable liquids include biological samples such as nasal samples, nasopharyngeal samples, saliva samples, urine, blood-based sample such as blood, plasma, or serum. The liquid may be derived from an environmental sample. For example, an environmental sample may be obtained by swabbing a surface such as within a food preparation, storage location, or medical facility. An environmental sample may include a soil or water sample. The liquid may include such biological samples combined within liquid regents such as one or more buffers, lysing media, Universal Transport Media (UTM), Viral Transport Media (VTM) or combinations thereof.

The liquid introduced to the device may also be contacted with reagent(s) within the microfluidic device such as within the application zone or supply channel extending distally therefrom. In such case, the liquid solubilizes the reagent(s) to prepare a liquid mixture containing the introduced liquid and solubilized reagent(s). A liquid segment is then prepared from such liquid mixture. The liquid segment may be contacted with or contain one or more additional reagents as disclosed herein.

In embodiments, a microfluidic device includes a generally planar substrate including a sample application zone and a microfluidic network including a microfluidic channel extending from an intersection between the sample application zone and the microfluidic channel. A porous membrane may overlie the sample application zone. A lower internal surface and an internal side wall of the sample application zone may be defined by the substrate. An upper internal surface of the sample application zone may be defined by a lower surface of the porous membrane. Additionally, or in combination, a lower internal surface, an upper internal surface, and first and second opposing internal side walls of the microfluidic channel are defined by the substrate. A portion of the substrate defining the upper internal surface of the microfluidic channel may project beyond the intersection between the sample application zone and the microfluidic channel and at least partially project into the sample application zone.

Substantially all, e.g., all, of the portion of the substrate that projects beyond the intersection into the sample application zone may underly the porous membrane.

The intersection between the sample application zone and the microfluidic channel may define a width between the first and second opposed internal side walls of the microfluidic channel. The width may be taken along a direction that is oriented generally perpendicular to a longitudinal axis of the microfluidic channel and parallel to a plane defined by the generally planar substrate. In some embodiments, the width of the intersection is at least about 0.75 mm, at least about 1.0 mm, at least about 1.25 mm, at least about 1.5 mm, e.g., about 1.5 mm and is less than about 2.5 mm, less than about 2.0 mm, e.g., less than about 1.75 mm.

In some embodiments, the portion of the substrate that projects beyond the intersection into the sample application zone overlies and may extend beyond the entire width of the intersection. In other embodiments, the portion of the substrate that projects beyond the intersection into the sample application zone is narrower than the width of the intersection. For example, at the intersection, the width of the projecting portion of the substrate may be between about 20% and 75% of the width of the intersection.

The portion of the substrate that projects beyond the intersection into the sample application zone may taper from a first width overlying the intersection to a second, smaller width disposed within the sample application zone.

The portion of the substrate that projects beyond the intersection into the sample application zone may extend for a distance of at least about 0.25 mm and less than about 1 mm, e.g., about 0.25 mm or about 0.5 mm, beyond the intersection into the sample application zone.

A height of the microfluidic channel taken along an axis perpendicular to the plane of the substrate, the height being between the lower and upper internal surfaces of the microfluidic channel at a location disposed 5 mm distal to the intersection along the longitudinal axis of the microfluidic channel may be at least about 50 μm and less than about 250 μm, e.g., about 110 μm. A height between the lower surface of the sample application zone and a lower surface of the portion of the substrate defining the upper internal surface of the microfluidic channel that projects beyond the intersection and into the sample application zone may be less than the microfluidic channel height. For example, a ratio of the sample application zone height and the channel height may be less than about 0.9. The ratio may be at least about 0.5, e.g., at least about 0.75.

In some embodiments, the substrate of the microfluidic device includes a lower layer that defines the lower internal surface of the sample application zone and the lower internal surface of the microfluidic channel, and an upper layer that defines the upper internal surface of the microfluidic channel and which includes the portion of the substrate defining the upper internal surface of the microfluidic channel that projects beyond the intersection into the sample application zone. The substrate may include a middle layer with the upper and lower layers spaced apart by and secured, e.g., adhered, to the middle layer. The middle layer may define the internal side wall of the sample application zone and the first and second opposing walls of the microfluidic channel.

The middle layer may include a middle layer aperture defining the internal side wall of the sample application zone, and wherein the upper layer may include an upper layer aperture overlying the middle layer aperture. A diagonal dimension of the upper layer aperture is typically greater than a diagonal dimension of the middle layer aperture. A perimeter portion of the lower surface of the porous membrane may be adhered to an upper surface of the middle layer that is adjacent the middle layer aperture and exposed by the upper layer aperture (e.g., exposed external to the microfluidic device).

In some embodiments, each of the upper, middle, and lower layers are separate layers with the upper and lower layers secured in opposition and spaced apart by the middle layer. In other embodiments, the middle layer is integral with one of the upper layer or lower layer. For example, the substrate may include two layers, with the first of the two layers defining the internal walls of the sample application zone and the microfluidic channel, and the lower internal surface of the sample application zone and microfluidic channel. The second of the two layers defines the upper internal surface of the microfluidic channel and the portion of the substrate defining the upper internal surface of the microfluidic channel that projects beyond the intersection into the sample application zone. As another example, the substrate may include two layers, with the first of the two layers defining the internal walls of the sample application zone and the microfluidic channel, and the upper internal surface of the microfluidic channel and the portion of the substrate defining the upper internal surface of the microfluidic channel that projects beyond the intersection into the sample application zone. The second of the two layers defines the lower internal surface of the sample application zone and the microfluidic channel. In each of these examples, at least the first of the two layers may be, e.g., a molded layer such as an injection molded layer.

The microfluidic device including the porous membrane may be configured to receive a particulate-containing liquid applied to an upper surface of the porous membrane, and separate at least some of the liquid from the particulates, so as to detect and/or measure at least one target within the separated liquid. For example, the particulate-containing liquid may be whole blood, the separated liquid may be plasma separated from red blood cells of the whole blood, and the at least one target may include any target suitable for determination in a plasma sample such as HbA1c or a cardiac marker such as troponin I or troponin C. Particulates are retained on upper surface of and/or within the porous membrane. The separated liquid, e.g., plasma, passes through the porous membrane into the sample application zone beneath the porous membrane. In embodiments, the separated liquid passes through the intersection into the microfluidic channel. The movement of the separated liquid through the intersection and along the microfluidic channel may be by capillary action and/or by applying a force to the separated liquid, e.g., by decreasing a pressure of a gas within the microfluidic channel disposed distally to the separated liquid so as to provide a motive force to move the separated liquid.

In embodiments, the microfluidic device includes a vent channel that extends from a vent intersection between the sample application zone and the vent channel. A distal portion of the vent channel is in gaseous communication with ambient gas surrounding the substrate so that gas disposed within the sample application zone may exit the sample application zone via the vent channel and/or ambient gas surrounding the substrate can enter the sample application zone via the vent channel. A lower internal surface, an upper internal surface, and first and second opposing internal side walls of the vent channel are defined by the substrate. A portion of the substrate defining the upper internal surface of the vent channel projects beyond the vent intersection into the sample application zone.

In some embodiments, the microfluidic device is configured to receive a whole blood sample via the sample application zone, thereby placing the whole blood sample in contact with an upper surface of the porous membrane, wherein red blood cells of the whole blood sample may be entrained on the upper surface of the porous membrane and/or within the porous membrane, and plasma separated from the whole blood sample by the porous membrane may be in contact with the lower surface of the porous membrane. At least some of the plasma may be in contact with the portion of the substrate defining the upper internal surface of the microfluidic channel that projects beyond the intersection into the sample application zone.

In embodiments, a microfluidic device includes a generally planar substrate including a sample application zone and a microfluidic network including a microfluidic channel extending from an intersection between the sample application zone and the microfluidic channel. A porous membrane may overlie the sample application zone. A lower layer of the substrate defines a lower internal surface and an internal side wall of the sample application zone. A lower surface of the porous membrane defines an upper internal surface of the sample application zone. The lower layer of the substrate may define a lower internal surface and first and second opposing internal side walls of the microfluidic channel. An upper surface of the lower layer of the substrate may comprise an adhesive surface. An upper layer of the substrate overlies the lower layer of the substrate and is secured to the adhesive surface thereof, and defines an upper internal surface of the microfluidic channel. A portion of the substrate defining the upper internal surface of the microfluidic channel projects beyond the intersection into the sample application zone. In embodiments, the lower layer of the substrate is formed of at least first and second lower layers. The first lower layer may be an adhesive layer that spaces apart and adheres together the upper layer and the second lower layer. Typically, at least some portions of the first lower layer are absent, thereby defining internal sidewalls of the microfluidic channel.

In embodiments, a microfluidic device includes a generally planar substrate including a sample application zone and a microfluidic network including a microfluidic channel extending from an intersection between the sample application zone and the microfluidic channel. A lower layer of the substrate defines a perimetrical internal side wall of the sample application zone and opposed internal side walls of the microfluidic channel. An upper layer of the substrate overlies the lower layer of the substrate. A lower surface of the upper layer of the substrate defines an upper internal surface of a distal portion of the microfluidic channel. The upper layer of the substrate comprises an opening surrounding the perimetrical internal side wall of the sample application zone. The opening exposes a perimetrical portion of the upper surface of the lower layer of the substrate. The perimetrical portion surrounds the perimetrical internal side wall of the sample application zone. A proximal portion of the microfluidic channel is disposed adjacent to the intersection between the sample application zone and the microfluidic channel. In the proximal portion of the microfluidic channel, a portion of the upper layer of the substrate has a width narrower than a width of the microfluidic channel, where each width is oriented generally parallel to the generally planar substrate and perpendicular to a longitudinal axis of the microfluidic channel in the proximal portion thereof. For example, a ratio of the width of the portion of the upper layer of the substrate to the width of the microfluidic channel in the proximal portion may be less than about 0.8, less than about 0.7, less than about 0.6, e.g., about 0.5. The ratio may be at least about 0.3, at least about 0.4, e.g., about 0.5. The width of the microfluidic channel in the proximal portion may between about 0.75 mm and 2.5 mm, e.g., between about 1 mm and 2 mm, e.g., about 1.5 mm. A length of the proximal portion of the microfluidic channel in which the portion of the upper layer has the narrower width may be between about 0.75 mm and 3 mm, between about 1 mm and 2 mm, e.g., about 1 mm where with length is taken along the longitudinal axis of the proximal portion of the microfluidic channel. The portion of the upper layer of the substrate may extend beyond the intersection into the application zone. For example, the upper layer of the substrate may extend for a length of between about 0.25 mm and about 1.5 mm, e.g., about 0.25 mm, or about 0.5 mm beyond the intersection.

A porous membrane may overlie the sample application zone. A lower surface of the porous membrane defines an upper internal surface of the sample application zone. A perimetrical portion of the lower surface of the porous membrane is secured to the exposed perimetrical portion of the upper surface of the lower layer of the substrate. A portion of the porous membrane may overlie the proximal portion of the microfluidic channel so that the lower surface of the porous membrane defines a portion of the upper internal surface of the proximal portion of the microfluidic channel. The lower surface of the narrower portion of the upper layer of the substrate defines remaining portions of the upper internal surface of the proximal portion of the microfluidic channel.

### BRIEF DESCRIPTION OF THE DRAWINGS

FIG. 1 is a planar top view of a microfluidic device configured to prepare a liquid segment from a volume of liquid introduced to the device and to mix the liquid of a liquid segment with one or more reagents to facilitate the determination of one or more targets within the liquid of the liquid segment, according to an embodiment described herein.

FIG. 2 is a planar top view of the microfluidic device of FIG. 1, with electrical elements thereof not shown for clarity and with a liquid having been introduced into a microchannel thereof via an application port and moved along the microchannel via capillary action until a distal liquid-gas interface of the sample liquid reached a capillary stop, according to an embodiment described herein.

FIG. 3 is a planar top view of the microfluidic device of FIG. 2, with a separating gas having been introduced into the microchannel to separate a liquid segment of the liquid from the remaining amount of sample liquid introduced into the microchannel, according to an embodiment described herein.

FIG. 4 is a planar top view of the microfluidic device of FIG. 3, with the liquid segment having been moved distally along the microchannel as compared to the position shown in FIG. 3, according to an embodiment described herein.

FIG. 5 is a planar top partial view of another embodiment of a microfluidic network of a microfluidic device configured to prepare a liquid segment from a volume of liquid introduced to a microchannel of the device and to mix the liquid of the liquid segment with one or more reagents, with electrical elements and gas chambers thereof not shown for clarity and with a liquid having been introduced into the microchannel thereof via an application port and moved along the microchannel via capillary action until a distal liquid-gas interface of the sample liquid reached a capillary stop, according to an embodiment described herein.

FIG. 6 is a planar top partial view of the microfluidic network of FIG. 5, where a separating gas has been introduced into a gas separation portion of the microchannel to prepare an initial gas-bubble for separating the liquid segment from a remaining portion of the sample liquid, according to an embodiment described herein.

FIG. 7 is a planar top partial view of the microfluidic network of FIGS. 5 and 6, where an additional amount of the separating gas has been introduced into the gas separation portion of the microchannel to prepare an asymmetric gas-bubble separating the liquid segment from a remaining portion of the sample liquid, according to an embodiment described herein.

FIG. 8 is a magnified planar top partial view of the gas separation portion of the microchannel of the microfluidic network as shown in FIG. 7, according to an embodiment described herein.

FIG. 9 is a magnified planar top partial view of the gas separation portion of the microchannel of the microfluidic network as shown in FIG. 8 also illustrating radii of curvature of gas-liquid interfaces of the asymmetric gas bubble within the gas separation portion of the microchannel, according to an embodiment described herein.

FIG. 10 is a planar top view of an embodiment of a microfluidic device configured to form a first segment including a sample liquid and a second segment including a diluent and then mix the first and second segments, where as shown, a blood sample has been introduced to a microfluidic network and formed a first segment, according to an embodiment described herein.

FIG. 11 is a planar top view of an embodiment of a microfluidic device configured to form a first segment including a sample liquid and a second segment including a diluent and then mix the first and second segments, where as shown in FIG. 11, a blood sample has been introduced to a microfluidic network and formed a first segment, according to an embodiment described herein.

FIG. 12a shows the microfluidic device of FIG. 11, with the first segment of blood having been moved proximally within the microfluidic network as compared to FIG. 11, according to an embodiment described herein.

FIG. 12b shows a magnified view of a segment combination region the microfluidic device of FIG. 12a, according to an embodiment described herein.

FIG. 13 shows the microfluidic device of FIG. 11, with a diluent having been introduced to the device and a proximal gas-liquid interface of the first segment of blood having been placed in contact with a distal gas-liquid interface of the diluent, according to an embodiment described herein.

FIG. 14 shows the microfluidic device of FIG. 13, with a segment of diluent having been separated from a remaining portion of the diluent, according to an embodiment described herein.

FIG. 15 shows the microfluidic device of FIG. 14, with the first segment of blood and the segment of diluent having been combined into a mixture by oscillatory action of gas pressure, according to an embodiment described herein.

FIG. 16 shows the microfluidic device of FIG. 15, with the mixture having been moved distally within the microfluidic network to a detection region, according to an embodiment described herein.

FIG. 17 is a planar top view of a microfluidic device configured to separate liquid from particulates, to form a segment of the separated liquid, to mix the segment of the separated liquid with one or more reagents to facilitate the detection of one or more targets within the sample liquid with electrical elements of the microfluidic device (not shown for clarity), according to an embodiment herein.

FIG. 18 is an exploded view of the microfluidic device of FIG. 17 illustrating the three-layer structure thereof, according to embodiment herein.

FIG. 19 is a detailed planar top view of the sample application zone of the microfluidic device of FIG. 17, the porous membrane overlying the sample application zone having been removed for clarity, according to an embodiment herein.

### DETAILED DESCRIPTION

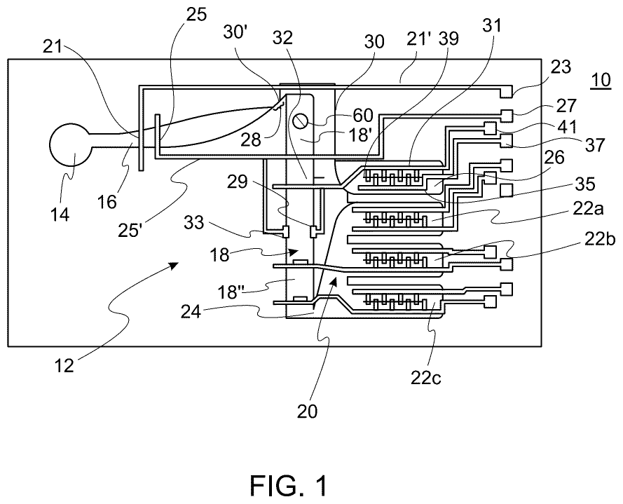

With reference to FIG. 1, a microfluidic device 10 is configured to receive a sample liquid, contact a portion (less than all) of the received sample liquid with one or more reagents disposed in a microchannel, prepare a liquid segment including essentially all or all of the portion of the received sample liquid in contact with and/or containing the reagent(s), mix the liquid of the liquid segment and the reagent(s), and determine the presence of one or more targets in the liquid of the liquid segment. As used herein, the term “microchannel” may be used interchangeably with the term “microfluidic channel”. The step of contacting the portion of the received sample liquid with the one or more reagents may be performed prior to and/or after preparing the liquid segment. For example, the preparation of the liquid segment may be performed with the sample liquid in contact with one or more of the reagents. Once prepared, the liquid segment includes all of the received sample liquid that is, or had been, in contact with the one or more reagents. Such liquid segment may be moved along the microchannel and into contact with one or more additional reagents. Alternatively, the liquid segment may be prepared without first contacting the reagents with the liquid thereof and, subsequently, the liquid segment may be moved along the microchannel and into contact with the one or more reagents.

The prepared liquid segment has a predetermined volume defined between a proximal gas-liquid interface and a distal liquid-gas interface. The one or more reagents are disposed in the microchannel in predetermined amount(s). Accordingly, the concentration(s) of the reagents within the mixture formed by subjecting the liquid segment to the mixing step is known whether or not the liquid segment is prepared from the received sample liquid in contact with one or more reagents or whether the liquid segment is contacted with such reagents after preparing the liquid segment (or both). In the absence of forming the liquid segment defined by such interfaces, bulk movement within the sample liquid induced by the mixing step may cause the one or more reagents to be distributed within an uncertain volume of the sample liquid so that the concentration of the one or more reagents is not known with the same precision as in the liquid segment. Because of the greater precision in the reagent(s) concentration(s) within the liquid segment, the determination of the one or more targets therein can be performed with greater precision than for the determination of such targets in a liquid in which reagent(s) are not confined within a liquid segment by the pair of interfaces (e.g., proximal and distal gas-liquid interfaces of the liquid segment).

Microfluidic device 10 includes a microfluidic network 12. Beginning with a sample application zone 14 and proceeding proximally to distally, microfluidic network 12 includes a microfluidic channel having a supply channel portion 16, a segment separation channel portion 28, an analysis channel portion 18 including a reagent zone 18′ and a detection zone 18″, and a gas chamber 20. The terms supply channel portion, segment separation channel portion, and analysis channel portion are respectively used interchangeably with the terms supply channel, segment separation channel, and analysis channel, respectively. Analysis channel 18 further includes a vent 32, which operates as a capillary stop, and one or more reagents 60 configured to facilitate the determination (e.g., detection) of the one or more targets in the liquid of the liquid segment. As an alternative to, or in combination with vent 32, the capillary stop may include a hydrophobic layer that extends partially or entirely across analysis channel 18, and/or a hydrophobic layer that extends along and within the vent 32. Microfluidic device 10 also includes a separation gas chamber 26 disposed in gaseous communication with segment separation channel 28 via a separation gas channel 30, which intersects separation channel 28 at a gas introduction opening 30′.

Microfluidic device 10 may be composed similarly to microfluidic strips of the '325 application. For example, device 10 may be composed of a lower substrate, e.g., a flexible polymer layer and an upper substrate, e.g., a flexible polymer layer, adhered in opposition by an adhesive layer. The adhesive layer occupies less than all of the area of opposing surfaces between the upper and lower substrates and includes side walls to define microfluidic network 12 therebetween. The upper and lower substrates and adhesive layer may have the same properties (e.g., thickness, composition, and mechanical properties) as disclosed for upper and lower substrates and adhesive layer of microfluidic strips disclosed in the '325 application. The internal height of microfluidic network 12 between internal surfaces of the upper and lower substrates is typically between about 50 μm and about 200 μm, e.g., about 110 μm.

Gas chamber 20 includes a plurality of spaced apart locations 22a, 22b, 22c disposed in gaseous communication with one another and in gaseous communication with analysis channel 18 via a gas chamber opening 24. Each of spaced apart locations 22a, 22b, 22c is spaced apart from an adjacent spaced apart location by an internal side wall which permit the upper lay overlying each spaced apart location to be compressed/decompressed and/or oscillated independently of the upper layer overlying the other spaced apart locations. Gas chamber 20 and spaced apart locations 22a, 22b, 22c may be configured, arranged and operated as disclosed in the '858 application. Separation gas chamber 26 is configured to introduce a separation gas through separation gas channel 30 and into segment separation channel 28 via gas introduction opening 30′ to separate a liquid segment from an amount of sample liquid present in microfluidic network 12. Separation gas chamber 26 may be configured, arranged and operated as disclosed as gas chambers in the '325 application. The term gas chamber may be used interchangeably with the term gas bladder.

Prior to the introduction of a liquid sample to microfluidic device 10, the ambient gas, e.g., air, surrounding microfluidic device can enter and exit microfluidic network 12 via application zone 14 and vent 32. There are no other routes via which gas may enter or exit microfluidic network 12. Accordingly, microfluidic network 12, e.g., the channels and chambers thereof, is occupied by such ambient gas.

Reagent 60 includes one or more reagents configured to facilitate detection of a target, e.g., reagents configured to bind to a target and labeled to permit detection of such reagents. The reagents may also include a magnetic particle reagent to permit the magnetic capture of the reagents. The one or more reagents may include, e.g., any of the reagents disclosed in the '325 Application. The one or more reagents may be disposed in the microchannel in a dry state and configured to be mobilizable when contacted by the liquid. The one or more reagents may be disposed within a single location or in two or more spaced apart locations. For example, the microchannel channel may include reagent(s) disposed in each of at least two locations spaced apart along the microchannel by a distance sufficient to permit contacting and mixing reagent(s) at a first location without also contacting the reagent(s) in a second location. Subsequently, the liquid, e.g., the liquid segment, is moved along the channel to the second location to permit contacting and mixing the reagent(s) therein.

Microfluidic device 10 also includes electrodes disposed and configured to permit a reader to monitor the proper filling of device 10 with sample liquid, the proper movement of sample liquid and a liquid segment therein, and as well as monitoring the operation (e.g., the compression state) of each spaced apart location 22a, 22b, 22c of gas chamber 20 and of separation gas chamber 26. The electrodes may be arranged, configured, and operated generally as disclosed in the '325 application and/or the '858 application. For example, device 10 includes a supply electrode 21 connected via lead 21′ to a contact 23 and a first fill electrode 25 and a second fill electrode 33 each connected via a common lead 25′ to a contact 27. When device 10 is fully inserted into a reader, contacts 23 and 27 engage corresponding contacts within the reader. The engaged contacts permit the reader to deliver and/or receive electrical signals to and/or from supply electrode 21, and fill electrode 25 and/or second fill electrode 33, to determine the presence of liquid sample at the respective locations of fill electrode 25 and fill electrode 33 as disclosed in the '325 Application. Microfluidic device 10 also includes electrodes configured to perform both a liquid sensing function and a mechanical sensing function. For example, lead 31 extends from a contact 41 through gas chamber 26 to a third fill electrode 29. Lead 35 extends from a contact 37 into gas chamber 26. Gas chamber 26 also includes a bridging contact 39. When gas chamber 26 is fully compressed, bridging contact 39 brings lead 31 and lead 35 into electrical communication, which is sensed by the reader via contacts 37 and 41. When leads 31,35 are not in electrical communication (i.e., when gas chamber 26 is not in a fully compressed state), a reader operating microfluidic device 10 may also use third fill electrode 29 to sense the presence of liquid in analysis channel 18. Spaced apart locations 22a,22b,22c also include corresponding electrodes and a corresponding bridging contact to permit a reader to determine when the locations are in a fully compressed state in the same way as for gas chamber 26.

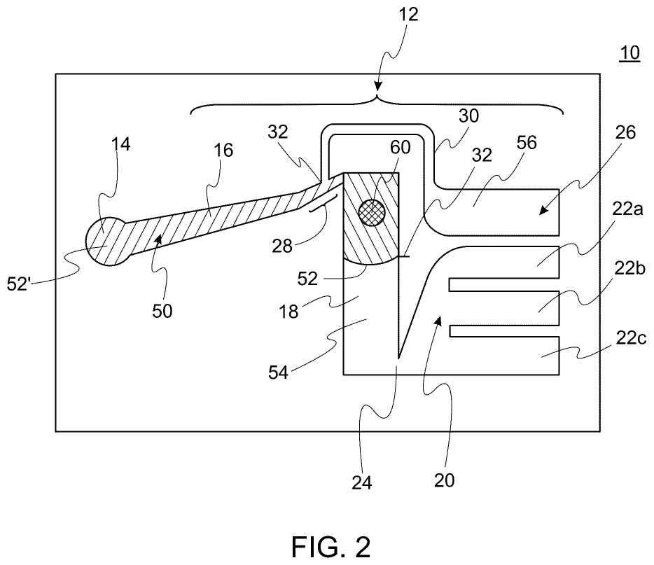

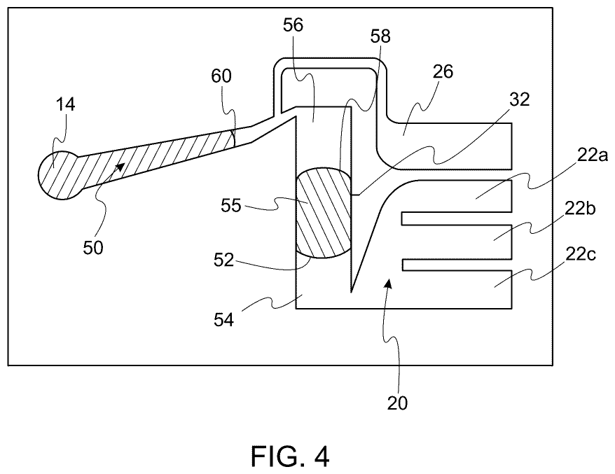

A method for forming a liquid segment and mixing the liquid of the liquid segment with a reagent is described with reference to FIGS. 2-4. The method begins by inserting microfluidic device 10 into a reader (not shown) as disclosed in the '325 application. The reader compresses spaced apart locations 22a, 22b, 22c of gas chamber 20 to an operational fully compressed state thereby expelling the gas therein through application zone 14 and vent 32. Separation gas chamber 26 remains in an uncompressed state. The method continues with the introduction of a sample liquid 50 into microfluidic network 12 via application zone 14. Sample liquid 50 moves by capillary action along supply channel 16, through segment separation channel 28 and into analysis channel 18 until a distal liquid-gas interface 52 of sample liquid 50 reaches vent 32, which acts as a capillary stop ceasing further motion of liquid sample 50. Sample liquid 50 then occupies microfluidic network 12 extending from a gas-liquid interface 52′ formed at application zone 14 to distal gas-liquid interface 52 located at vent 32 (FIG. 2).

Gas chamber 20, including spaced apart locations 22a, 22b, 22c, and portions of analysis channel 18 distal to distal liquid-gas interface 52 are occupied by a gas 54. Separation gas chamber 26 and separation gas channel 30 are occupied by a gas 56. As an example, gas 54 and gas 56 may consist of remaining ambient gas, e.g., air, that had occupied microfluidic network prior to the introduction of sample liquid 50. Because sample liquid 50 occupying microfluidic network 12 obstructs vent 32 and application zone 14, gas 54 and gas 56 are isolated from one another and from the ambient gas surrounding microfluidic device 10.

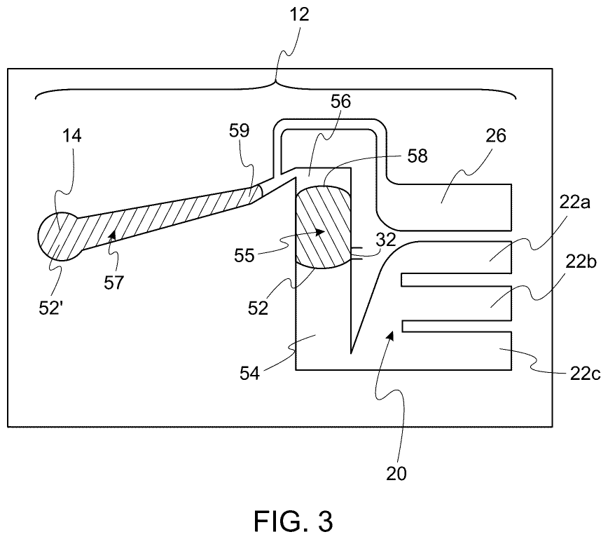

As shown in FIG. 2, sample liquid 50 contacts reagent(s) 60 within analysis channel 18. The sample liquid begins to mobilize the reagent(s). Because sample liquid 50 ceased moving along the microchannel and is not subjected to active mixing at this stage, mixing of sample liquid 50 and reagent(s) 60 is driven by slow diffusion. Accordingly, reagent(s) 60 do not distribute within sample liquid 50 by an amount sufficient to create volume uncertainty as discussed above. With reference to FIG. 3, separation gas chamber 26 is compressed, increasing the pressure of gas 56 therein and forcing gas 56 through separation gas channel 30 and into separation channel 28 via gas introduction opening 30′. The introduction of gas 56 into separation channel 28 separates a liquid segment 55 from a remaining portion 57 of sample liquid 50 (shown in FIG. 2). Liquid segment 55 includes a proximal gas-liquid interface 58, all of sample liquid 50 in contact with and/or containing reagent(s) 60, and distal liquid-gas interface 52. That is, remaining portion 57 of sample liquid 50 does not include any of reagent 60. Instead, all of reagent 60 is contained in and/or in contact with the liquid of liquid segment 55. Remaining liquid portion 57 includes a distal liquid-gas interface 59. Gas 56 may occupy at least a portion of the supply channel 16, and the separation channel 28, and is isolated from the ambient gas surrounding device 10 by the remaining liquid portion 57 (which obstructs application zone 14) and from such ambient gas and gas 54 by liquid segment 55 (which obstructs vent 32 and separates gases 54 and 56). As an alternative to introducing the separation gas by compressing a separation gas chamber, a chamber containing the separation gas may be heated, thereby increasing the pressure of the separation gas and introducing the separation gas into the microchannel containing the sample liquid and separating the liquid segment from the remaining liquid. The heating may be performed by, e.g., using a resistive conductor within the chamber.

Microfluidic network 12 may also include reagents disposed at different locations along the analysis channel 18, and/or at locations different from the analysis channel 18, e.g., at locations of the microfluidic network disposed proximally to analysis channel 18. For example, application zone and/or supply channel 16 may include one or more reagents to facilitate the determination of a target such as to lyse and/or disrupt cells within the sample liquid to release contents of the cells and/or one or more reagents, such as heparin, to reduce clotting of a blood-based sample liquid. In such embodiments, such proximally disposed reagents may contact a significant portion, e.g., most or essentially all, of the introduced sample liquid so that the concentration(s) of such reagent(s) is not known with the same precision as for the concentration(s) of reagent(s) when contacted with a fixed volume of the liquid segment. However, a liquid segment may be prepared from such reagent-containing sample liquid and contacted with additional reagents before and/after preparing the liquid segment. In such case, the concentration(s) of the additional reagent(s) in the liquid segment would be known with greater precision as disclosed herein.

After separating liquid segment 55 from remaining portion 57 of sample liquid 50, the reader may actuate the oscillation of the pressure of gas 54 within gas chamber 20, and/or the oscillation of the pressure of gas 56 within gas chamber 26. The oscillation may be performed, e.g., as disclosed in the '325 application and '858 application including via the use of a piezoelectric actuator. For example, the compression, decompression and/or oscillation of each spaced apart location 22a, 22b, 22c of gas chamber 20, and of gas chamber 26, may be performed using a respective piezoelectric actuator having an actuation foot to independently compress, decompress and/or oscillate, e.g., synchronously, an upper wall overlying each spaced apart location 22a, 22b, 22c and/or gas chamber 26. Oscillating the upper wall at each spaced apart location oscillates the volume occupied by gas 54 (and therefore the pressure of gas 54) within gas chamber 20 by oscillating a spacing between opposed internal walls at each spaced apart location. As an alternative, or in combination with the oscillation of the pressure of gas 54, the pressure of gas 56 may be oscillated, e.g., synchronously at the same frequency, out of phase with but at the same frequency, or at a frequency different from the frequency of oscillation of gas 54.

Oscillating the pressure of distal gas 54 induces bulk movement of liquid within liquid segment 55 thereby distributing reagent(s) 60 throughout the liquid segment and establishing a uniform concentration distribution therein. The bulk movement of liquid mixes the liquid of liquid segment 55 and the reagent(s) more rapidly than could be achieved by diffusion alone. Proximal gas-liquid interface 58 and distal liquid-gas interface 52 of liquid segment 55 prevent the reagent(s) from exiting the liquid segment during oscillatory mixing. Accordingly, mixing within liquid segment 55 provides a mixture with a known, uniform concentration of reagent(s) 60. The volume of liquid segment 55 is determined by the volume of the microchannel between (i) the intersection of gas introduction opening 30′ of separation gas channel 30 with separation channel 28 and (ii) the capillary stop, e.g., vent 32. The aforementioned volume of the microchannel is determined by the internal dimensions of the microchannel, e.g., the cross-sectional area, and the distance along the microchannel between (i) the intersection of gas introduction opening 30′ of separation gas channel 30 and separation channel 28 and (ii) vent 32 and/or a hydrophobic layer if present. Typically, the dimensions and distance are selected to provide a liquid segment having a volume of, e.g., between about 0.2 L and about 2.5 μL, e.g., between about 0.2 μL and about 0.750 μL, e.g., about 0.35 μL.

Liquid segment 55 may be moved distally along the microchannel, e.g., within analysis channel 18, by decreasing the pressure of gas 54 acting upon distal liquid-gas interface 52. For example, the pressure of gas 54 may be decreased by decreasing a compression of one or more of spaced apart locations 22a,22b,22c within gas chamber 20. Decreasing the compression may be performed, e.g., as disclosed in the '325 application and '858 application such as via the use of a piezoelectric actuator in contact with an outer wall of microfluidic device 10 overlying the spaced apart locations. Decreasing the compression increases a volume of gas chamber 20 by increasing a spacing between opposed internal walls at each spaced apart location 22a,22b,22c. The distal movement of liquid segment 55 may be performed to, for example, bring the liquid of liquid segment 55 into contact with other reagent(s) disposed within analysis channel 18 and/or to bring liquid segment into detection zone 18″ therein.

After liquid segment 55 has contacted and been mixed with all of the reagent(s) necessary to perform determination (e.g., detection) of the target, the liquid segment is subjected to a detection step to perform such determination. Such detection step may include, e.g., fluorescence or other optical detection and/or electrochemical detection. Any of the detection steps disclosed in the '325 application may be performed. For example, the reagent may include a magnetic particle and the detection step may include subjecting the liquid segment to a magnetic field to capture the magnetic particles. The detection step may then include compressing one or more, e.g., all, of the spaced apart locations 22a, 22b, 22c or the gas chamber 26 to increase the pressure of gas 54 thereby removing, e.g., expelling, the liquid of liquid segment 55 in contact with the captured magnetic particles from detection zone 18″ (e.g., separating the liquid of liquid segment 55 from the captured magnetic particles) prior to the detection. Alternatively, the detection step may then include decompressing one or more, e.g., all, of the spaced apart locations 22a, 22b, 22c or the gas chamber 26 to decrease the pressure of gas 54 thereby removing, e.g., withdrawing, the liquid of liquid segment 55 in contact with the captured magnetic particles from detection zone 18″. As another example, the detection step may then include decompressing, on the one hand, one or more, e.g., all, of the spaced apart locations 22a, 22b, 22c or the gas chamber 26 and compressing the other of one or more, e.g., all, of the spaced apart locations 22a, 22b, 22c or the gas chamber 26 thereby removing the liquid of liquid segment 55 by a combination of expelling and withdrawing gas pressures.

In embodiments, microfluidic device 10 comprises two or more microfluidic networks 12 that may each be configured to receive a sample liquid, mix with one or more reagents, and independently perform an analysis on the sample liquid to, for example, detect a presence or absence of a target in the sample liquid. In some embodiments, each microfluidic network comprises the same components as described herein for microfluidic network 12, which includes for example, a microfluidic channel having a supply channel portion 16, a segment separation channel portion 28, an analysis channel portion 18 including a reagent zone 18′ and a detection zone 18″, and a gas chamber 20. In some embodiments, the supply channel portion for each microfluidic network branches off a common channel that extends from the application zone. Accordingly, two or more microfluidic networks are configured analyze a sample liquid simultaneously.

The two or more microfluidic networks may be located adjacent to each other on the microfluidic device. In embodiments, at least some of the microfluidic networks have the same reagent(s) so as to provide a redundant analysis of the sample liquid. Such redundancy may serve as a check in the event of any contamination or fault in a given microfluidic network, and further provide more precision and adjustability for any sensitivity with the sample liquid.

In some cases, at least some of the microfluidic networks have one or more different reagents from each other, thereby allowing for one or more different targets to be detected in a sample liquid by a microfluidic device. Such detection of different targets may be performed simultaneously.

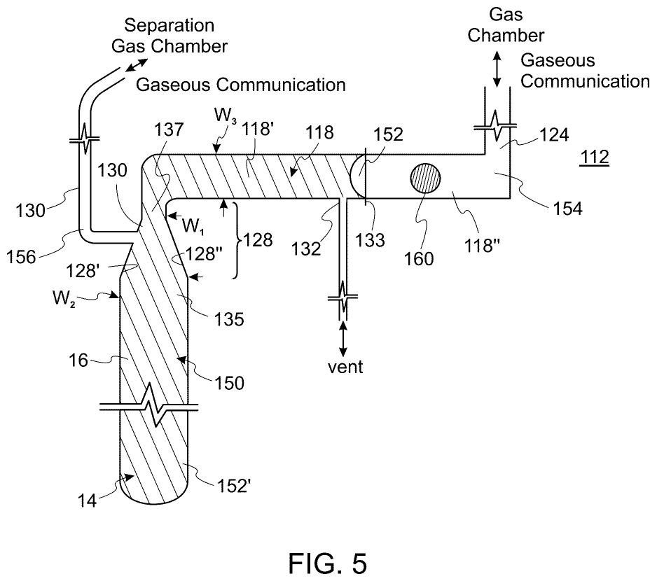

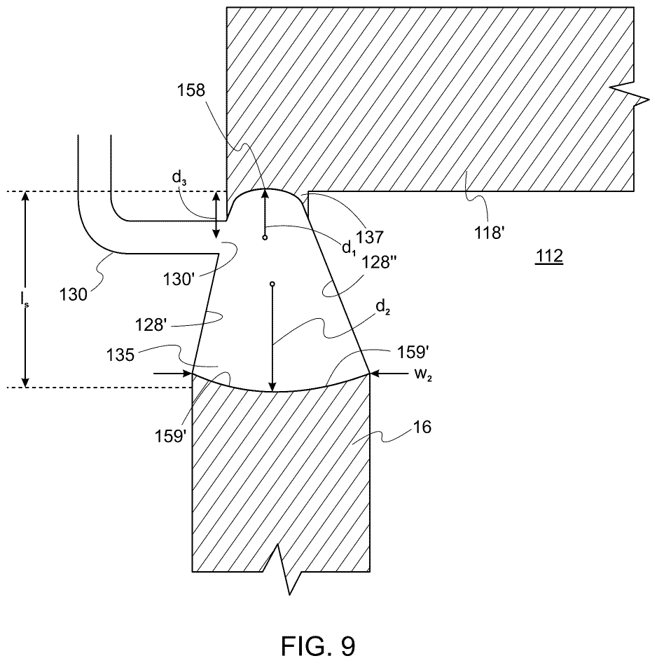

With reference to FIGS. 5-9, depicts another exemplary microfluidic network 112 (where only a portion of the microfluidic network is shown) of a microfluidic device, where the microfluidic network includes a tapered segment separation channel 128 for separating a liquid segment from a liquid introduced to the microfluidic network. Microfluidic network 112 includes a supply channel 16 extending from a sample application zone 14, a segment separation channel 128 and an analysis channel 118 including a reagent zone 118′ and a detection zone 118″. A vent 132 and/or a hydrophobic layer in the form of a hydrophobic strip 133 may be located on an interior surface of analysis channel 118 and may act as a hydrophobic stop. A width w4 of vent 132 along analysis channel 118 is typically between about 75 μm and about 300 μm, e.g., about 150 μm. Microfluidic network 112 also includes a separation gas channel 130 having an opening 130′ that connects to segment separation channel 128. Separation gas channel 130 leads to a separation gas bladder, which may be configured to be operated as described for separation gas bladder 26 of microfluidic network 10. A distal portion of analysis channel 118 includes a gas chamber opening 124 that connects to a gas chamber, which may be configured to be operated as described for separation gas bladder 26 of microfluidic network 10. Microfluidic network 112 further includes electrical features (not shown) as discussed for microfluidic device 10. The internal height of microfluidic network 112 is typically between about 50 μm and about 200 μm, e.g., about 110 μm.

Segment separation channel 128 has a length between a proximal separation origin 135 and a distal separation terminus 137. The segment separation channel 128 length is typically between about 1.5 mm and about 4.5 mm, e.g., about 3 mm. A width of segment separation channel 128 is defined by first and second tapered side walls 128′,128″. The width between side walls 128′,128″ tapers from a width w2 at proximal separation origin 135 to a narrower width w1 at distal separation terminus w1. Width w2 is typically between about 800 μm and 2200 μm, e.g., about 1650 μm. Width w1 is typically between about 400 μm and 1200 μm, e.g., about 800 μm. A ratio w2/w1 of the widths is typically at least about 1.25, e.g., is between about 1.5 and 3.5, e.g., is about 2. The width of segment separation channel 128 typically decreases at an average rate of between about 12% mm⁻¹ and about 25% mm⁻¹, e.g., about 17.5% mm⁻¹, proceeding therealong from proximal separation origin 135 to distal separation terminus 137. The height of segment separation channel 128 is typically constant or substantially constant. The term “substantially” as used herein may refer to less than or equal to +/−1%, +/−2%, +/−3%, +/−4%, +/−5%, +/−6%, +/−7%, +/−8%, +/−9%, +/−10%, +/−11%, +/−12%, +/−14%, or +/−15% variation. Accordingly, the cross-sectional area (not illustrated) of tapered gas separation channel 128 tapers from a first cross-sectional area A2 at proximal separation origin 135 to a smaller cross-sectional area A1 at distal separation terminus 137. For example, cross-sectional area A1 may be between about 0.044 mm² and about 0.13mm², e.g., about 0.09mm², and the second cross-sectional area A2 may be between about 0.13 mm² and about 0.24mm², e.g., about 0.18mm². The ratio of the cross-sectional areas (proximal separation origin 135 area A2/distal separation terminus 137 area A1) may be the same as for the ratio of widths (w2/w1) so that, e.g., A2 is about equal to A1×w2/w1. The cross-sectional area of segment separation channel 128 may decrease proceeding from proximal separation origin 135 to distal separation terminus 137 at the same relative rate of decrease as for the width thereof.

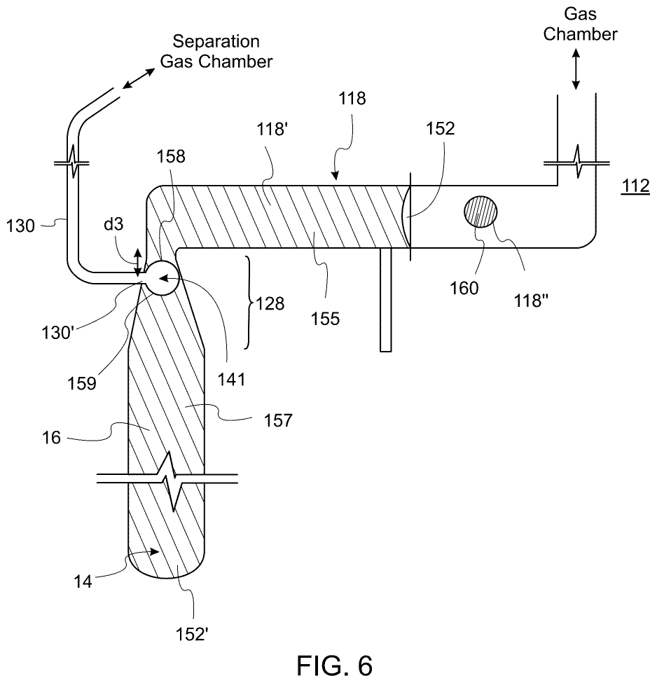

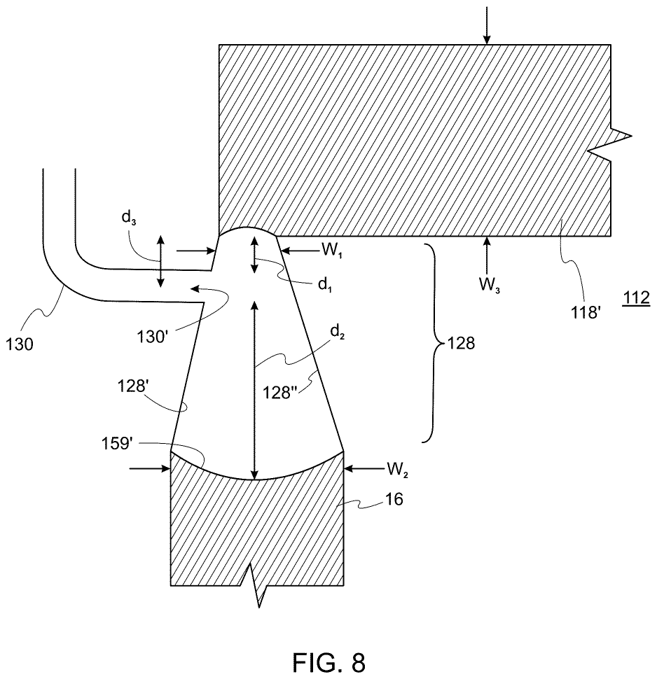

Separation opening 130′ has a width w5 along first tapered side wall 128′ of segment separation channel 128. Width w5 is typically between about 75 μm and about 300 μm, e.g., about 150 μm. A distance d3 (FIGS. 6 and 8) between the center of separation opening 130′ and distal separation terminus 137 is between about 300 μm and about 1000 μm, e.g., about 750 μm. Proceeding distally along segment separation channel 128 from the center of separation opening 130′ to distal separation terminus 137, the width between tapered walls 128′ and 128″ tapers as described above. Proceeding distally beyond distal separation terminus 137, the width of the microchannel widens from width w1 at distal separation terminus 137 to a width w3 within analysis channel 118. Width w3 is greater than width w1. Width w3 is typically between 800 μm and about 3000 μm, e.g., about 2000 μm. A ratio of widths w3/w1 is typically between about 1 and 3.5, e.g., about 2.5.

Reagent zone 118′ of analysis channel 118 includes one or more reagents disposed and composed as described for reagent 60 of microfluidic device 10. For example, reagent 60 may include reagents configured to prepare a sample for analysis of a sample. For example, the reagent may be a heparin reagent to inhibit coagulation of a blood sample or lysing reagents configured to lyse cells to release their contents for analysis. In FIGS. 5-9, microfluidic network 112 is illustrated with a sample liquid that has already contacted and solubilized such reagent(s). The microfluidic network is used to prepare a liquid segment comprising all of such contacted and solubilized reagent(s).

Prior to the introduction of a liquid sample to microfluidic network 112, the ambient gas, e.g., air, surrounding the microfluidic device containing network 112 can enter and exit microfluidic network 112 via application zone 14 and vent 132. There are no other routes via which gas may enter or exit microfluidic network 112. Accordingly, microfluidic network 112, e.g., the channels and chambers thereof, is occupied by such ambient gas.

A method for forming a liquid segment using microfluidic network 112 proceeds in a similar fashion to the process described for microfluidic device 10. The method begins by inserting a microfluidic device containing microfluidic network 112 into a reader (not shown) as disclosed in the '325 application. The reader compresses the gas chamber of microfluidic network 112 (e.g., distal to gas chamber channel 124) to an operational fully compressed state thereby expelling the gas therein through application zone 14 and vent 132. The separation gas chamber remains in an uncompressed state. The method continues with the introduction of a sample liquid 150 into microfluidic network 112 via application zone 114. Sample liquid 150 moves by capillary action along supply channel 16, through segment separation channel 128 and into analysis channel 118 until a distal liquid-gas interface 152 reaches vent 132 and/or hydrophobic strip 133, either of which act may as a capillary stop ceasing further motion of liquid sample 150. As shown in FIG. 5, sample liquid 150 then occupies portions of microfluidic network 112 extending from a gas-liquid interface 152′ formed at application zone 14 to distal gas-liquid interface 152 located at vent 132. Within analysis channel 118, sample liquid 150 may contact with one or more reagent(s) therein, and mixes by diffusion as described for sample liquid 50 within microfluidic network 12 of microfluidic device 10.

The gas chamber of microfluidic network 112 and portions of analysis channel 118 distal to distal liquid-gas interface 152 are occupied by a gas 154, which has the same composition and properties as gas 54. The separation gas chamber of microfluidic network 112 and separation gas channel 130 are occupied by a gas 156, which has the same composition and properties as gas 56. Gas 154 and gas 156 consist of remaining ambient gas, e.g., air, that had occupied microfluidic network 112 prior to the introduction of sample liquid 150. Because sample liquid 150 occupying microfluidic network 112 obstructs vent 132 and application zone 14, gas 154 and gas 156 are isolated from one another and from the ambient gas surrounding the microfluidic device containing microfluidic network 112.

With reference to FIG. 6, the pressure of gas 156 with the separation gas chamber of microfluidic network 112 is increased, e.g., by compressing the separation gas chamber as described for separation gas chamber 56 of microfluidic device 10, thereby forcing gas 156 through separation gas channel 130 and into separation channel 128 via gas introduction opening 130′. The introduction of gas 156 into separation channel 128 forms an initial gas bubble 141 separating a liquid segment 155 from a remaining liquid portion 157 within microfluidic network 112. Initial gas bubble 141 and liquid segment 155 form a gas liquid interface 158 and initial gas bubble 141 and remaining liquid 157 form a gas-liquid interface 159.

The liquid of liquid segment 155 consists essentially of the amount of sample liquid 150 that had been disposed within microfluidic network 112 between gas introduction opening 130′ and distal gas-liquid interface 152. The volume of liquid segment 155 is typically between about 0.75 μL and about 4 μL, e.g., between about 1.5 μL and about 3 μL, e.g., about 2 μL. A smaller volume of sample liquid, e.g., between about 150 nL and about 5 nL, e.g., about 350 nL may enter vent 132 and is not considered part of liquid segment 155. The liquid of remaining liquid portion 157 is the amount of sample liquid 150 that had been disposed within microfluidic network 112 between gas introduction opening 130′ and application zone 14.

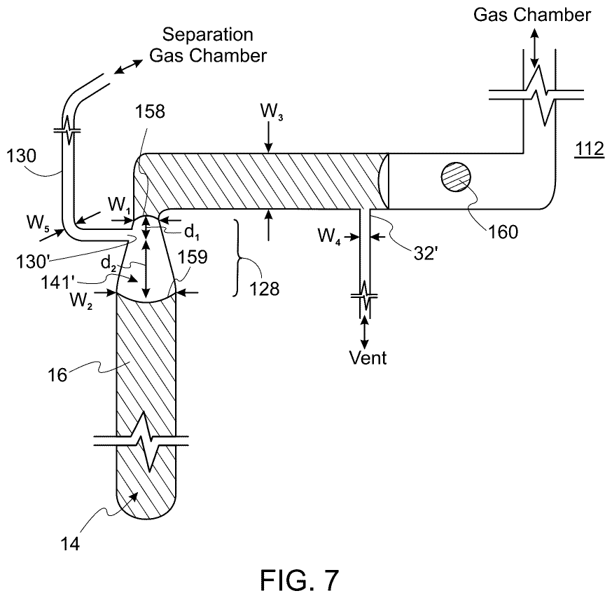

With reference to FIGS. 7-9, the pressure of gas 156 within the separation gas chamber of microfluidic network 112 has been further increased increasing the volume of initial gas bubble 141 to a final gas bubble 141′. Because walls 128′,128″ taper narrower proceeding distally from the location of gas-liquid interface 158 (e.g., the width of separation channel 128 between walls 128′,128″ decreases proceeding distally along separation channel 128 from the location of gas-liquid interface 158), a radius of curvature r1 of gas-liquid interface 158 would have to decrease in order for gas-liquid interface 158 to move distally as additional gas is introduced from the separation gas chamber through opening 130′. The radius of curvature r1 is defined in a plane parallel both to the longitudinal axis of the separation channel and to the greater of the width or height of the separation channel at the location of gas liquid interface 158. In the embodiment of FIGS. 5-9, radius of curvature r1 is in a plane parallel to the longitudinal axis of the separation channel and to the width of the separation channel because the width is greater than the height at the location of gas liquid interface 158. In embodiments, the radius of curvature of each interface is measured along a radial axis that is aligned with the longitudinal axis of the channel and perpendicular to the width of the channel at the location of the interface, and wherein the radius of curvature of the interface may also be parallel to a plane of the generally planar microfluidic device.

Moving liquid segment 155 distally along the separation channel would decrease the radius of curvature of gas-liquid interface 158 thereby increasing the surface tension and energy of this interface. Accordingly, gas-liquid interface 158 resists distal movement and remains at essentially the same location along segment separation channel 128 as the additional separation gas is introduced. Because gas-liquid interface 158 remains at essentially the same location, liquid segment 155 also remains at essentially the same location and essentially no additional liquid enters vent 132.

Gas-liquid interface 159 however, can move proximally within segment separation channel 128 because the width of the channel 128 expands proceeding proximally thereby increasing the radius of curvature of interface 159 until interface 159 forms interface 159′ having a radius of curvature r2, wherein r2>r1. Radius of curvature r2 may be defined in the same plane as radius of curvature r1. The differing radii of curvature give gas bubble 141′ an asymmetric shape. A ratio r2/r1 is about the same as the ratio of the widths of the channel 128 at the corresponding locations of the gas liquid interfaces 158,159′ of bubble 141′. For example, the ratio r2/r1 may be about the same as the ratio w2/w1 when the interfaces are at the locations of w2 and w1 as shown in FIG. 7. Increasing the radius of curvature of interface 159′ reduces the surface tension and energy of interface 159′ as compared to gas-liquid interface 159 of initial gas bubble 141. Accordingly, in some cases, the pressure or energy required of the separating gas in the segment separating channel 128 to move liquid segment 155 will be larger than for remaining liquid 157 due to the smaller cross-sectional area of gas-liquid interface 158 exposed to the separating gas pressure or energy as compared to the larger cross-sectional area of gas-liquid interface 159′. Thus, the entering separating gas will preferentially move remaining liquid 157 proximally over moving liquid segment 155 distally. A distance along the microchannel between the gas-liquid interface 158 and gas-introduction opening 130′ is a distance d1, a distance along the microchannel between the gas-liquid interface 159′ and the gas-introduction opening 130′is a distance d2, and a ratio d2/d1 is at least about 2.25, e.g., is between about 2.25 and 10, e.g., about 4.5. For example, d1 may be between about 250 μm and 1000 μm, e.g., about 500 μm and d2 may be between about 1000 μm and about 2750 μm, e.g., about 2000 μm.

After separating liquid segment 155 from remaining portion 157 of sample liquid 150 and forming gas-bubble 141′, the reader actuates the oscillation of the pressure of gas 154 within the gas chamber of microfluidic network 112 to facilitate mixing of reagents in contact with liquid segment 155. The oscillation may be performed, e.g., as disclosed for device 10 and in the '325 application and '858 application, for example, including via the use of a piezoelectric actuator. The pressure of gas 154 may then be reduced drawing liquid segment 155 distally and into contact with additional reagents 160 within detection region 118″ of analysis channel 118. Additional reagents 160 typically include one or more reagents configured to bind a target within the sample. For example, reagents 160 may include one or more different particles including a binding agent such as an antibody for the target. The particles may include, e.g., magnetic particles and fluorescent particles and the particles may be configured to form a detectable sandwich with the target. The target may then be detected within detection region 118″, e.g., optically or electrochemically.

In embodiments, microfluidic device 210 comprises two or more microfluidic networks 112 that may each be configured to receive a sample liquid, mix with one or more reagents, and independently perform an analysis on the sample liquid to, for example, detect a presence or absence of a target in the sample liquid. In some embodiments, each microfluidic network comprises the same components as described herein for microfluidic network 112, which includes for example, a supply channel 16, a tapered segment separation channel 128, an analysis channel 118 including a reagent zone 118′and a detection zone 118″, a gas chamber, a separation gas chamber, a separation gas channel, a vent 132 and/or a hydrophobic layer in the form of a hydrophobic strip 133 that may be located on an interior surface of analysis channel 118 and may act as a hydrophobic stop. In some embodiments, the supply channel portion for each microfluidic network branches off a common channel that extends from the application zone 14. Accordingly, two or more microfluidic networks are configured analyze a sample liquid simultaneously.

The two or more microfluidic networks may be located adjacent to each other on the microfluidic device. In embodiments, at least some of the microfluidic networks have the same reagent(s) so as to provide a redundant analysis of the sample liquid. Such redundancy may serve as a check in the event of any contamination or fault in a given microfluidic network, and further provide more precision and adjustability for any sensitivity with the sample liquid.

In some cases, at least some of the microfluidic networks have one or more different reagents from each other, thereby allowing for one or more different targets to be detected in a sample liquid by a microfluidic device. Such detection of different targets may be performed simultaneously.

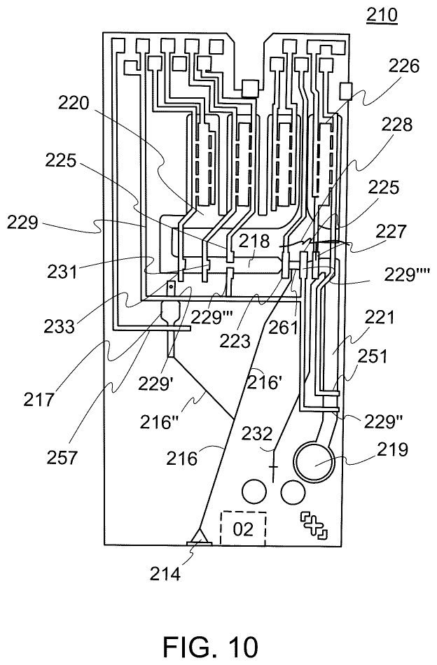

Referring to FIGS. 10-16, a microfluidic device 210 is configured to combine two liquid segments each having a known precise volume to prepare a mixture of the two liquids having a known concentration. In the embodiment illustrated, one of the liquids is a biological sample, e.g., blood, and the other liquid is a diluent such as a buffer. Other liquids may be used. Microfluidic device 210 includes a microfluidic network having a sample introduction zone 214, a primary sample introduction channel 216, a hematocrit introduction channel 216″, a hematocrit detection chamber 217, a secondary sample introduction channel 216′, a segment combination chamber 228, an analysis channel 218, a diluent application zone 219, and a diluent introduction channel 221.

A first gas chamber 220 communicates with a distal portion of analysis channel 218. Gas chamber 220 may be configured as gas chamber 20 of device 10. A combination gas chamber 226 communicates with segment combination chamber 228 via a segment gas channel 241 at a segment gas opening 241′, which may have the same dimensions as opening 130′ of microfluidic network 112.

Device 210 also includes electrical features to monitor the presence of sample and diluent liquids and to monitor the compression status of the gas chambers 220 and 226. A signal emitting lead 229 includes signal emitting electrodes 229′,229″,229″′,229″″ disposed within the microfluidic network to be in electrical communication with liquid present at the respective location of each electrode. Signal emitting lead 229 and corresponding electrodes are configured to emit a time varying signal as disclosed in the '325 application. Device 210 includes electrical sensing features including sense electrode 251, sense electrode 227, sense electrode 223, sense electrode 255, sense electrode 231, sense electrode 233, and sense electrode 257. The aforementioned sense electrodes cooperate with emitting electrodes to detect the presence of liquid at the location of each sense electrode as disclosed in the '325 application. Each of the emitting and sense electrodes are disposed on an inner surface of the microchannel network of device 210. In addition, microfluidic network 210 includes a hydrophobic strip overlying or underlying sense electrode 223 and a hydrophobic strip overlying or underlying emitting electrode 229″″. The hydrophobic strips are obscured by the sense electrode or emitting electrode in the figures. Each hydrophobic strip cooperates with sense electrode 223 and emitting electrode 229″″ to create a hydrophobic barrier, e.g., a capillary stop that prevents liquid from moving either distally or proximally beyond the locations by capillary flow.

The operation of strip 210 proceeds as follows. Prior to operation, gas chamber 226 is compressed as discussed for gas chamber 26 of device 10. As seen in FIG. 10, a blood sample is applied to application zone 214 and flows by capillary flow along primary sample introduction channel 216. A portion of the blood flows along hematocrit introduction channel 216″ and fills hematocrit detection chamber 217. The proper fill of blood within chamber 217 is confirmed by sensing the signal emitted by emitting electrode 229′ via sense electrode 257. A second portion of the blood flows along secondary sample introduction channel 216 and forms a blood segment 261 within the volume of segment combination chamber 228 disposed between sense electrode 223 (and the corresponding hydrophobic strip) and the emitting electrode 229″″ (and the corresponding hydrophobic strip). The length along chamber 228 between sense electrode 223 and emitting electrode 229′″ is between about 500 μm and 2000 μm, e.g., about 1400 μm. A width of chamber 228 between sense electrode 223 and emitting electrode 229″″ is between about 500 μm and 1750 μm, e.g., about 1000 μm. The height within the chamber is between about 50 μm and about 200 μm, e.g., about 110. The volume of blood segment 261 is determined by the aforementioned dimensions and is typically between about 75 nL and 500 nL, e.g., about 150 nL. The proper fill of blood is confirmed by sensing the signal emitted by emitting electrode 229″″ via sense electrode 233.

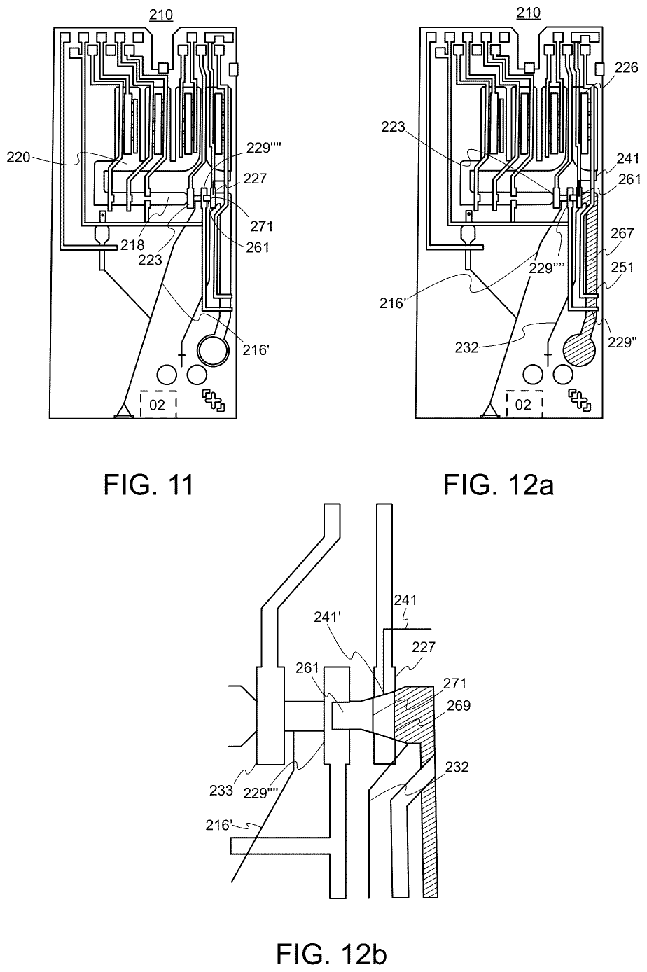

With reference to FIG. 11, the pressure of gas within gas chamber 220 is increased, e.g., as discussed for gas chamber 20. The increased gas pressure forces blood segment 261 proximally within chamber 228 beyond emitting electrode 229″″ (and the corresponding hydrophobic strip) until a proximal gas-liquid interface 271 of blood segment 261 contacts sense electrode 227 thereby placing sense electrode 227 in electrical communication with emitting electrode 229″″. Upon sensing the presence of blood segment 261 at sense electrode 227, compression of gas chamber 220 is ceased.

Referring to FIGS. 12a, 12b, a diluent 267 (e.g., a buffer) is introduced to diluent application zone 219. Diluent 267 flows by capillary action along diluent introduction channel 221 until a distal gas-liquid interface of diluent 267 moves distally beyond vent 232. As best seen in FIG. 12b in which sense electrode 227 has been illustrated as partially transparent for clarity, proximal interface 271 of blood segment 261 and distal interface 269 of diluent 267 are separated by a small amount of gas (e.g., air). The pressure of gas within gas chamber 226 is reduced drawing the gas separating proximal interface 271 and interface 269 and a small amount of diluent 267 through opening 241′ into channel 241 thereby permitting blood segment 261 to contact and/or merge with diluent 267. The hydrophobic strip and emitting electrode 229″″ prevent proximal interface 271 of blood segment 261 from moving proximally as pressure of gas within gas chamber 226 is reduced thereby maintaining the volume and position of blood segment 261. Instead, distal interface 269 of diluent 267 moves distally along segment combination chamber 228 until interface 269 merges with interface 271 of blood segment 261.

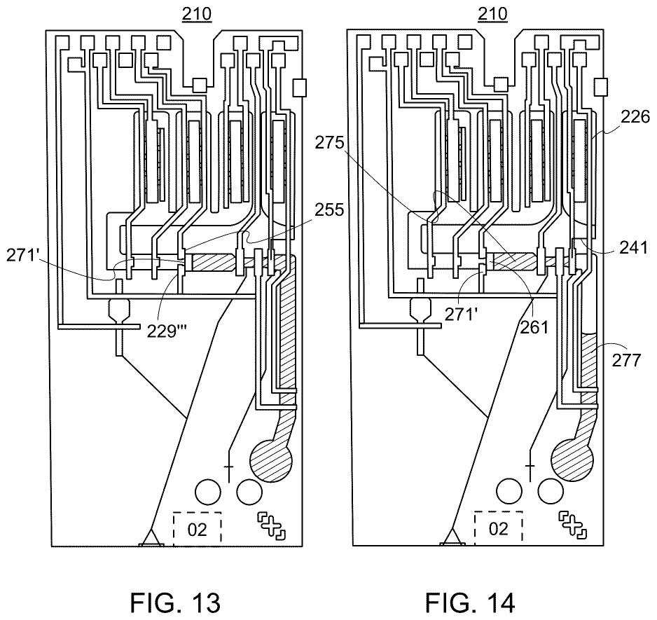

Referring to FIG. 13, the pressure of gas within gas chamber 220 is reduced drawing blood segment 261 and diluent 267 distally along analysis channel 218 until a distal gas-liquid interface 271′ established electrical communication between emitting electrode 229″″ and sense electrode 255 at which point the presence of liquid is detected and the operation of gas chamber 220 is ceased.

Referring to FIG. 14, the pressure of gas within separation gas chamber 226 is increased thereby forcing gas into chamber 228 via channel 241 and opening 241′ thereby splitting diluent 267 into a diluent segment 275 and a remaining portion 277. The splitting of diluent 267 into diluent segment 275 and remaining portion 277 is performed after merging distal interface 269 of diluent 267 with interface 271 of blood segment 261.

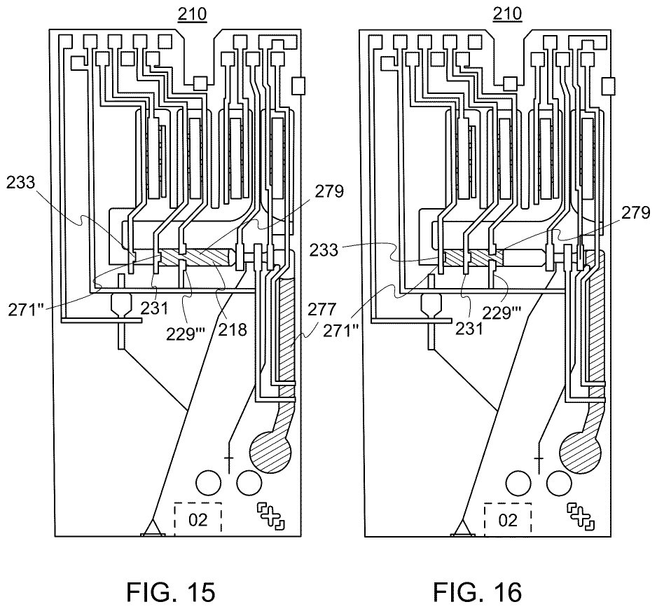

Referring to FIG. 15, the pressure of gas within gas chamber 220 is again decreased drawing blood segment 261 and diluent segment 275 distally along analysis channel 218 until distal gas liquid interface 271′ of blood segment 261 contacts sense electrode 231 establishing electrical communication between sense electrode 231 and emitting electrode 229″″ at which point the presence of liquid is detected and the operation of gas chamber 220 is ceased. Analysis channel 218 may include reagents to facilitate a determination of a target, e.g., reagents for determination of the HbA1c content of the blood segment 261. After ceasing movement of the blood segment 261 and diluent segment 275, the pressure of the gas within chamber 220 and/or separating gas chamber 226 is/are oscillated as discussed for device 10 thereby mixing blood segment 261, diluent segment 275, and such reagents to form a sample segment 279. Oscillation may also be performed during at least a portion, e.g., most, or all, of the time that blood segment 261 and diluent segment 275 are moved distally. Exemplary suitable reagents and processes for determining HbA1c are disclosed in U.S. application Ser. No. 17/409,279, filed Aug. 23, 2021, which application is incorporated by reference herein in its entirety.

Referring to FIG. 16, the pressure of gas within gas chamber 220 is again decreased drawing sample segment 279 distally along analysis channel 218 until a distal gas liquid interface 271″ of sample segment 279 contacts sense electrode 233 establishing electrical communication between sense electrode 233 and emitting electrode 229′″ at which point the presence of liquid is detected and the operation of oscillating gas chamber 220 is ceased. Analysis channel 218 may include additional reagents disposed between sense electrodes 231 and 233 that are contacted and mobilized by sample segment 279. The gas pressure within gas chamber 220 may be oscillated to enhance mixing of such reagents and sample segment 279. Subsequently, the presence of a target, e.g., HbA1c, is detected.

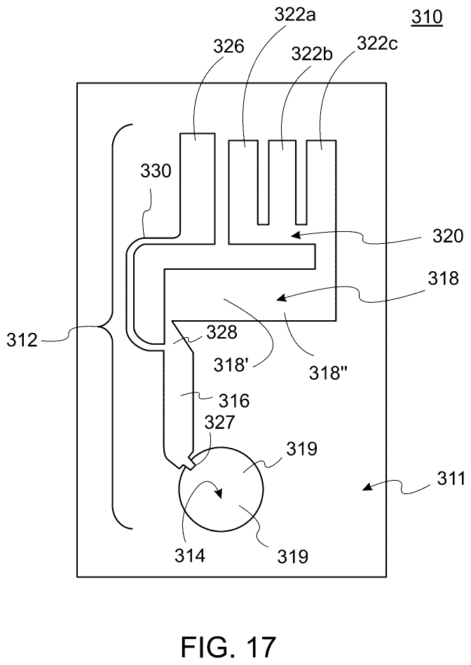

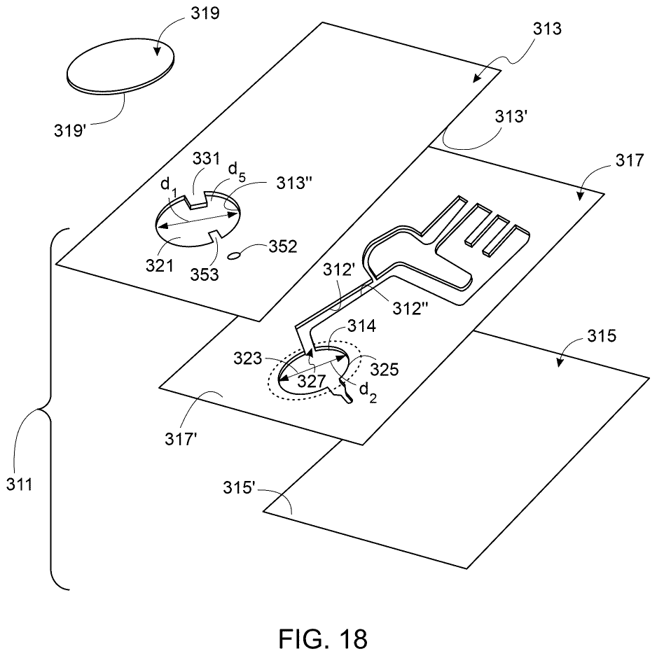

Referring to FIGS. 17-19, a microfluidic device 310, according to some embodiments, is configured to receive a particulate-containing liquid, separate at least some of the liquid from the particulates, form a segment containing some of the liquid separated from the particulates, and determine the presence or absence of at least one target in the liquid of the separated segment. For example, the particulate containing liquid may be whole blood, the separated liquid may be plasma separated from red blood cells of the whole blood, and the at least one target may be a cardiac marker such as troponin I or troponin C.

Microfluidic device 310 includes a generally planar substrate 311 defining a microfluidic network 312 therein. Beginning with a sample application zone 314 and proceeding proximally to distally, microfluidic network 312 may include a microfluidic channel having a supply channel portion 316, a segment separation channel portion 328, an analysis channel portion 318 including a reagent zone 318′ and a detection zone 318″, a gas chamber 320, a separation gas chamber 326, or any combination thereof. A porous membrane 319 overlies sample application zone 314. Microfluidic device may further include i) electrical features such as electrodes for determining the compression of gas chambers 320,326 and the presence of liquid sample within microfluidic network 312, and/or ii) vents and capillary stops as disclosed for microfluidic devices 10,210 and microfluidic network 112. For clarity, such features are not shown in FIGS. 17,18. The dimensions, e.g., width, height, and length as well as the function and operation of elements of microfluidic network 312, e.g., supply channel portion 316, segment channel portion 328, analysis channel 318, gas chambers 320,326, and separation gas channel 330 may be similar to, e.g., to the same as, the corresponding elements of microfluidic devices 10,210 and microfluidic network 112.

Referring to FIG. 18, substrate 311 may include an upper layer 313 and a lower layer 315 adhered in opposition by a middle layer 317. Upper layer 313 and lower layer 315 may be formed of a polymer, e.g., polyester, and each may a typical total thickness of between about 80 and 130 μm, e.g., about 100 μm. Middle layer 317 may be formed of a central layer of polymer, e.g., a polypropylene having upper and lower layers of adhesive. Middle layer 317 may have a typical total thickness of between about 80 and 150 μm, e.g., about 110 μm.

A lower internal surface of microfluidic channel and application zone 314 may be defined by an upper surface 315′ of lower layer 315. An upper internal surface of microfluidic network 312 including microfluidic channel 316 may be defined by a lower surface 313′ of upper layer 313. An upper internal surface of application zone 314 may be defined by a lower surface 319′ of porous membrane. Internal sidewall 314′ of application zone 314 and opposed internal sidewalls 312′,312″ of microfluidic channel 316 may be defined by middle layer 317.

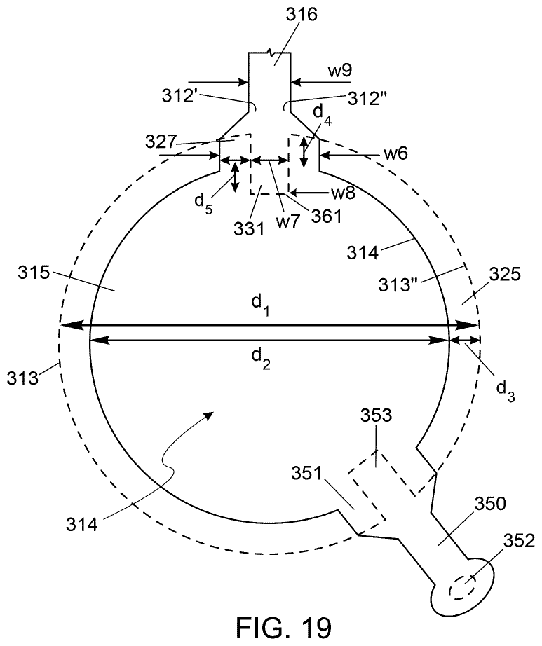

Upper layer 313 includes a first application zone aperture 321 define by a side wall 313″ and having a maximum diagonal d1 (FIGS. 18,19) along an axis parallel to the plane of substrate 311. Middle layer 317 includes a second application zone aperture defining internal side wall 314′ and having a maximum diagonal d2 (FIGS. 18,19) along an axis parallel to the plane of substrate 311. First application zone aperture d1 of upper layer 313 is larger than second application zone aperture d2 of middle layer 317 so that first application zone aperture d1 exposes a perimeter portion 325 of adhesive upper surface 317′. A perimeter portion of lower surface 319′ of porous membrane is adhered to perimeter portion 325 of adhesive upper surface 317′. For example, porous membrane 319 may be secured to substrate 311 by positioning porous membrane 319 so that the perimeter portion of lower surface 319′of porous membrane 319 is in contact with and overlies perimeter portion 325 of adhesive upper surface 317′. Pressure and/or heat may be applied to secure porous membrane 319 and substrate 311 together. Perimeter portion 325 has a radial width d3 (FIG. 19) sufficient to adhere porous membrane 319 to middle layer 317. Width d3 is typically between about 1 mm and 3 mm, e.g., about 2 mm.

Sample application zone 314 and microfluidic channel 316 intersect at an intersection 327 from which microfluidic channel 316 extends. A projecting portion 331 of upper layer 313, the lower surface 313′of which defines the upper surface of microfluidic channel 316 extends beyond intersection 327 into sample application zone 314. Substantially all, e.g., all of projecting portion 331 underlies porous membrane 319.

Intersection 327 defines a width w6 between the first and second opposed internal side walls 312′,312″ of microfluidic channel 316 at the location of intersection 327. Width w6 is taken along a direction that is oriented generally perpendicular to a longitudinal axis of microfluidic channel 316 at the location of intersection 327 and parallel to a plane defined by microfluidic device 310. Width w6 may be, e.g., about 1.5 mm. Microfluidic channel 316 defines a width w9 adjacent intersection 327. A ratio of widths w6/w9 is typically between about 1 and about 3, e.g., about 2.

Projecting portion 331 extends for a distance d5 beyond sample application zone sidewall 314′ into sample application zone 314. Distance d5 is typically at least about 0.25 mm and is typically less than about 1 mm, e.g., about 0.25 mm or about 0.5 mm. Projecting portion 331 has a total length d4 taken from side wall 313″ of first application zone aperture 321 to a tip 361 of projecting portion 331.

A width w7 of projecting portion 331 at the location of intersection 327 is narrower than width w6 of intersection 327. For example, at intersection 327, width w7 of projecting portion 331 is typically between about 20% and 75% of width w6 of intersection 327. Projecting portion 331 tapers from width w7 at intersection 327 to a smaller width w8 disposed within sample application zone 314. A ratio of widths w8/w7 is typically between about 0.5 and 0.9, e.g., about 0.75.

In embodiments, the projection portion help with alignment of the porous membrane. For example, the porous membrane may help in preventing or reducing the risk of the porous membrane obstructing or at least partially obstructing the opening to the microfluidic channel 316.

Microfluidic device 310 includes a vent channel 350 that extends from a vent intersection 351 between sample application zone 314 and vent channel 350. A distal portion 352 of vent channel 350 is in gaseous communication with ambient gas surrounding the substrate so that gas disposed within sample application zone 314 may exit sample application zone 314 via vent channel 350 and/or ambient gas surrounding microfluidic device 310 can enter sample application zone 314 via vent channel 350. A lower internal surface of vent channel 350 is defined by upper surface 315′ of lower layer 315. An upper internal surface of vent channel 350 is defined by lower surface 313′ of upper layer 313. Opposed internal side walls of vent channel 350 are defined by middle layer 317. A projecting portion 353 of upper layer 313 defining the upper internal surface of vent channel 350 projects beyond vent intersection 351 into the sample application zone 314.

Microfluidic device 310 may be operated as follows. A particulate-containing liquid, e.g., blood, is applied to the upper surface of porous membrane 319. Particulates, e.g., red blood cells, are retained on upper surface of and/or within porous membrane 319. The separated liquid, e.g., plasma, passes through porous membrane 319 into the sample application zone 314 therebeneath. The separated liquid passes through intersection 327 into microfluidic channel 316. Ambient gas enters and exits sample application zone 314 via vent 352 thereby equalizing pressure therein as the separated liquid enters and exits sample application zone 314. At least some of the separated liquid enters segment separation channel portion 328. A segment of the separated liquid is formed, e.g., as disclosed for the embodiments of FIGS. 1-9. One or more targets is detected within the liquid of the liquid segment.

### Numbered Embodiments

Embodiment 1: A microfluidic device, comprising: a generally planar substrate comprising a microfluidic network therein, the microfluidic network comprising i) a distal gas chamber configured to adjust a pressure of a distal gas within at least a portion of the microfluidic network; ii) a microfluidic channel extending distally from an application zone to the distal gas chamber, the application zone configured to receive a sample liquid therein; and iii) a separation gas chamber in communication with the microfluidic channel via a separation gas channel that intersects the microfluidic channel at a separation gas introduction location, the separation gas chamber configured to adjust a pressure of a separation gas within at least a portion of the microfluidic network; wherein, the sample liquid is configured to flow from the application zone through at least a portion of the microfluidic channel to a capillary stop located distal to the separation gas introduction location, such that introduction of the separation gas into the microfluidic channel thereafter forms a separation gas bubble within the microfluidic channel that separates the sample liquid therein into i) a liquid segment located distal to the separation gas bubble, and ii) a remaining volume of sample liquid located proximal to the separation gas bubble, the liquid segment forming i) a distal gas-liquid interface disposed between the distal gas and the liquid segment, and ii) a proximal gas-liquid interface disposed between the separating gas and the liquid segment.

Embodiment 2: The microfluidic device of claim 1, wherein the microfluidic channel comprises a reagent zone distal to the separation gas introduction location and configured to comprise one or more reagents.

Embodiment 3: The microfluidic device of claim 2, wherein the reagent is configured to solubilize with the sample liquid when contacted therewith.

Embodiment 4: The microfluidic device of claim 2 or 3, wherein the reagent is configured to enable detection of a target in the sample liquid upon contact therewith.

Embodiment 5: The microfluidic device of claim 4, wherein the microfluidic channel comprises a detection zone distal to the reagent zone and configured to detect a presence or absence of the target within the sample liquid.

Embodiment 6: The microfluidic device of any one of claims 1 to 5, wherein the distal gas chamber comprises a first inner wall, a second inner wall, and a distal chamber spacing therebetween that is configured to be occupied by the distal gas.

Embodiment 7: The microfluidic device of claim 6, wherein an outer wall of the distal gas chamber is configured to be contacted with an oscillating member so as to oscillate and/or adjust the distal chamber spacing, thereby oscillating and/or adjusting the pressure of the distal gas.

Embodiment 8: The microfluidic device of claim 7, wherein adjusting the pressure of the distal gas facilitates movement of the liquid segment within the microfluidic channel.

Embodiment 9: The microfluidic device of claim 7, wherein the oscillating member is configured to contact the outer wall of the distal gas chamber at a location spaced apart along the microfluidic channel from the distal liquid-gas interface by a distance of at least about 5 mm, at least about 7.5 mm, at least about 10 mm, or at least about 15 mm.

Embodiment 10: The microfluidic device of any one of claims 1 to 9, wherein the separating gas chamber is configured to heat the separating gas therein so as to pressurize the separation gas and facilitate introduction thereof into the microfluidic channel to form the separation gas bubble.

Embodiment 11: The microfluidic device of any one of claims 1 to 9, wherein the separation gas chamber comprises a third inner wall, a fourth inner wall, and a separation gas chamber spacing therebetween that is configured to be occupied by the separation gas.

Embodiment 12: The microfluidic device of claim 11, wherein an outer wall of the separation gas chamber is configured to be contacted with a second oscillating member so as to oscillate and/or adjust the separation gas chamber spacing, thereby oscillating and/or adjusting the pressure of the separation gas.

Embodiment 13: The microfluidic device of any one of claims 1 to 13, wherein the separating gas bubble defines a volume of separating gas disposed between the proximal gas-liquid interface and a gas-liquid interface between the remaining volume of the sample liquid and the separating gas bubble (RVSL gas-liquid interface), the separation gas bubble disposed within a separation zone of the microfluidic channel.

Embodiment 14: The microfluidic device of claim 13, wherein the separating zone of the microfluidic channel tapers distally from a larger cross-sectional area to a smaller cross-sectional area.

Embodiment 15: The microfluidic device of claim 13 or 14, wherein the proximal gas-liquid interface occupies a portion of the microfluidic channel having a cross-sectional area A1, wherein the RVSL gas-liquid interface occupies a portion of the microchannel having a cross-sectional area A2, and wherein A2 is greater than A1 such that the separating gas bubble comprises an asymmetrical shape.

Embodiment 16: The microfluidic device of claim 15, wherein upon introduction of the separating gas into the microfluidic channel, a radius of curvature of the proximal gas-liquid interface is smaller than a radius of curvature of the RVSL gas-liquid interface, such that further introduction of the separating gas moves the RVSL gas-liquid interface proximally while leaving the proximal gas-liquid interface at or substantially at the same position within the microfluidic channel, such that the liquid segment i) remains at or substantially the same position within the microfluidic channel, and/or ii) has the same or substantially the same amount of volume within the microfluidic channel.

Embodiment 17: The microfluidic device of claim 15 or 16, wherein a ratio of A2 to A1 (“R_{A}”) is at least about 1.25.

Embodiment 18: The microfluidic device of any one of claims 15 to 17, wherein cross-sectional area Al is between about 0.04 mm² and about 0.13mm².

Embodiment 19: The microfluidic device of any one of claims 15 to 18, wherein a distance along a longitudinal axis of the microfluidic channel between the RSVL and proximal gas-liquid interfaces is between about 1 and 3 mm.

Embodiment 20: The microfluidic device of any one of claims 14 to 19, wherein the cross-sectional area of the microfluidic channel between the RSVL and proximal gas-liquid interfaces decreases at an average rate of between about 12% mm⁻¹ and about 25% mm⁻¹.

Embodiment 21: The microfluidic device of any one of claims 14 to 20, wherein a distance along the microfluidic channel between the RSVL gas-liquid interface and the separation gas introduction location is a distance d1, wherein a distance along the microfluidic channel between the proximal gas-liquid interface and the separation gas introduction location is a distance d2, and wherein a ratio d2/d1 is between about 2.25 and 10.

Embodiment 22: The microfluidic device of any one of claims 14 to 21, wherein the proximal gas-liquid interface is disposed in the separation zone, and wherein the sample liquid of the liquid segment is substantially disposed in a reagent zone or a detection zone of the microfluidic channel located distally to the separation zone, the reagent zone or detection zone having a cross-sectional area A3 that is larger than cross-sectional area A1.

Embodiment 23: The microfluidic device of any one of claims 1 to 22, wherein the generally planar substrate comprises an upper layer, a lower layer, and a middle layer disposed between the upper and lower layers.

Embodiment 24: The microfluidic device of claim 23, wherein the middle layer comprises an upper surface having an adhesive to adhere to the upper layer, a lower surface having an adhesive to adhere to the lower layer, or both.

Embodiment 25: The microfluidic device of claim 23 or 24, wherein an upper surface of the lower layer defines a lower internal surface of the microfluidic channel and the application zone. Embodiment 26: The microfluidic device of any one of claims 23 to 25, wherein a lower surface of the upper layer defines an upper internal surface of the microfluidic channel.

Embodiment 27: The microfluidic device of any one of claims 23 to 26, wherein the upper layer, the lower layer, the middle layer, or any combination thereof comprises an aperture defining the application zone.

Embodiment 28: The microfluidic device of any one of claims 23 to 27, further comprising a porous membrane configured to overlie the application zone.

Embodiment 29: The microfluidic device of claim 28, wherein the porous membrane is configured to separate the sample liquid from one or more particulates.

Embodiment 30: The microfluidic device of any one of claims 23 to 29, further comprising a projection extending from the upper layer and/or the middle layer into the application zone.

Embodiment 31: The microfluidic device of any one of claims 1 to 30, wherein the microfluidic device further comprises one or more additional microfluidic networks, wherein each of the one or more additional microfluidic networks is configured to independently receive a portion of the sample liquid from the application zone and analyze the sample liquid to detect a target therein. Embodiment 32: The microfluidic device of claim 31, wherein two or more of the microfluidic channel and the one or more additional microfluidic channels are configured to analyze the sample liquid simultaneously or in series.

Embodiment 33: The microfluidic device of claim 31 or 32, wherein at least one of the one or more additional microfluidic channels is configured in the same manner as the microfluidic network of any one of claims 1 to 30.

Embodiment 34: A method, comprising: a) introducing a sample liquid into a microfluidic channel within a microfluidic device, the microfluidic channel containing a distal gas therein, such that the sample liquid contacts the distal gas, thereby forming a distal liquid-gas interface therebetween; b) introducing a separating gas into the microfluidic channel at a location occupied by the sample liquid, thereby separating a segment of the sample liquid from a remaining volume of the sample liquid introduced into the microfluidic channel, the liquid segment comprising (i) the distal liquid-gas interface, (ii) a portion of the sample liquid introduced into the microfluidic channel, and (iii) a proximal gas-liquid interface between the separating gas and the portion of the sample liquid, wherein the separating gas separates the proximal gas-liquid interface of the liquid segment from the remaining volume of the sample liquid; c) moving the liquid segment to a reagent zone of the microfluidic channel by decreasing a pressure of the distal gas, the reagent zone comprising at least one reagent disposed therein; and d) mixing the portion of the sample liquid of the liquid segment with the at least one reagent by oscillating the pressure of the distal gas and/or a pressure of the separating gas, thereby forming a first mixture; wherein oscillating the pressure of the distal gas and/or separating gas is performed i) prior to, ii) concurrent with, and/or iii) after decreasing the pressure of the distal gas.

Embodiment 35: A method for analyzing a sample liquid to detect at least one target material therein, the method comprising: a) introducing the sample liquid into a microfluidic channel within a microfluidic device, the microfluidic channel containing a distal gas therein, such that the sample liquid contacts the distal gas, thereby forming a distal liquid-gas interface therebetween; b) moving the sample liquid along the microfluidic channel until at least some of the sample liquid contacts at least one reagent disposed within a reagent zone of the microfluidic channel; c) introducing a separating gas into the microfluidic channel at a location occupied by the sample liquid, thereby separating a segment of the sample liquid from a remaining volume of the sample liquid introduced into the microfluidic channel, the liquid segment comprising (i) the distal liquid-gas interface, (ii) a portion of the sample liquid in contact with the at least one reagent, and (iii) a proximal gas-liquid interface disposed between the separating gas and the portion of the sample liquid, wherein the separating gas separates the proximal gas-liquid interface of the liquid segment from the remaining volume of the sample liquid; and d) mixing the portion of the sample liquid of the liquid segment with the at least one reagent by oscillating a pressure of the distal gas and/or a pressure of the separating gas thereby forming a first mixture.

Embodiment 36: The method of claim 35, wherein moving the sample liquid is via capillary action.

Embodiment 37: The method of claim 35, wherein moving the sample liquid is via decreasing a pressure of the distal gas.

Embodiment 38: The method of claim 37, wherein oscillating the pressure of the distal gas and/or separating gas is performed i) prior to, ii) concurrent with, and/or iii) after decreasing the pressure of the distal gas.

Embodiment 39: The method of any one of claims 34 to 38, wherein oscillating the pressure of the pressure of the distal gas and/or separating gas is performed at a frequency of about 2000 Hz or less, about 1500 Hz or less, about 1250 Hz or less, about 1000 Hz or less, about 900 Hz or less, about 800 Hz or less, from about 5 Hz to about 2500 Hz, or from about 10 Hz to about 2000 Hz.

Embodiment 40: The method of any one of claims 34 to 39, wherein the step of oscillating comprises oscillating the pressure of the distal gas and, during the step of oscillating, the distal liquid-gas interface occupies a location of the microfluidic channel having a cross sectional area of at least about 0.01mm², at least about 0.02mm², at least about 0.03mm², at least about 0.04 mm², at least about 0.05mm², at least about 0.06mm², or at least about 0.07mm².

Embodiment 41: The method of any one of claims 34 to 40, wherein the step of oscillating comprises oscillating the pressure of the distal gas and, during the step of oscillating, the distal liquid-gas interface occupies a location of the channel having a cross sectional area of about 0.15 mm² or less, about 0.125 mm² or less, about 0.1 mm² or less, about 0.09 mm² or less, or about 0.08 mm² or less.

Embodiment 42: The method of any one of claims 34 to 41, wherein, during the step of oscillating, the liquid segment has a volume of at least about 0.2 μL or more, at least about 0.3 μL or more, at least about 0.4 μL or more, or at least about 0.5 μL or more.

Embodiment 43: The method of any one of claims 34 to 42, wherein, during the step of oscillating, the liquid segment has a volume of about 2 μL or less, about 1.75 μL or less, about 1.5 μL or less, about 1.25 μL or less, about 1 μL or less, about 0.75 μL or less, or about 0.5 μL or less.

Embodiment 44: The method of any one of claims 34 to 43, wherein introducing the sample liquid comprises moving the sample liquid by capillary action along the microfluidic channel until the distal sample liquid-gas interface contacts a capillary stop within the microfluidic channel.

Embodiment 45: The method of claim 44, wherein introducing the sample liquid comprises moving the sample liquid by capillary action along the microfluidic channel until the distal liquid-gas interface reaches and moves beyond the location at which the separating gas will be introduced.

Embodiment 46: The method of claim 43 or 44, wherein the capillary stop comprises one or more vents providing gaseous communication between the microfluidic channel and a volume of gas disposed externally to the microfluidic channel.

Embodiment 47: The method of claim 46, wherein the volume of gas comprises ambient air surrounding the microfluidic device.

Embodiment 48: The method of any of claims 34 to 47, wherein after introducing the sample liquid into the microfluidic channel, the distal gas occupies a chamber of the microfluidic device that is isolated with respect to an ambient gas surrounding the microfluidic device.

Embodiment 49: The method of claims 34 to 45 or 48, wherein, prior to introducing the liquid sample into the microfluidic channel, the microfluidic channel provides a sole route for gaseous communication between the distal gas and the exterior of the microfluidic device.

Embodiment 50: The method of any of claims 48 or 49, wherein after introducing the liquid sample into the microfluidic channel, the distal gas occupies a chamber of the microfluidic device that is isolated with respect to an ambient gas surrounding the microfluidic device.

Embodiment 51: The method of claim 46, wherein, prior to introducing the liquid sample into the microfluidic channel, the microfluidic channel and the one or more vent(s) provide the only route for gaseous communication between the distal gas and the exterior of the microfluidic device.

Embodiment 52: The method of any of claims 48 to 51, wherein the ambient gas surrounding the microfluidic device is ambient air surrounding the microfluidic device.

Embodiment 53: The method of any one of claims 34 to 52, wherein oscillating the pressure of the distal gas comprises oscillating an internal spacing between a first inner wall and a second inner wall of a region of the microfluidic channel occupied by the distal gas, the region being distal to the liquid segment.

Embodiment 54: The method of claim 53, wherein the region is a distal gas chamber of the microfluidic device and the first and second internal walls are internal walls of the chamber.

Embodiment 55: The method of claim 54, wherein the oscillating the internal spacing between the first and second walls of the distal gas chamber comprises oscillating the internal spacing at a location of the distal gas chamber that is spaced apart along the microfluidic channel from the distal liquid-gas interface.

Embodiment 56: The method of claim 55, wherein the oscillating comprises contacting an outer wall of the distal gas chamber with an oscillating member.

Embodiment 57: The method of claim 56, wherein the oscillating member contacts the outer wall of the distal gas chamber at a location spaced apart along the microfluidic channel from the distal liquid-gas interface by a distance of at least about 5 mm, at least about 7.5 mm, at least about 10 mm, or at least about 15 mm.

Embodiment 58: The method of any one of claims 34 to 57, wherein after introducing the liquid sample into the microfluidic channel, the separating gas occupies a separating gas chamber of the microfluidic device that is sealed with respect to an ambient gas surrounding the microfluidic device.

Embodiment 59: The method of claim 58, wherein the ambient gas is air.

Embodiment 60: The method of claim 58 or 59, wherein introducing the separating gas comprises heating the separating gas within the separating gas chamber.

Embodiment 61: The method of any one of claims 34 to 60, wherein the step of introducing the separating gas comprises increasing the pressure of the separating gas within the separating gas chamber.

Embodiment 62: The method of claim 61, wherein the method further comprises decreasing a pressure of the distal gas during at least a portion of the step of increasing the pressure of the separating gas within the separating gas chamber.

Embodiment 63: The method of any one of claims 34 to 62, wherein the method further comprises operating the microfluidic device with an instrument, and wherein the method is performed without introducing any gas from a gas source of the instrument into the microfluidic channel.

Embodiment 64: The method of any one of claims 34 to 63, wherein, prior to introducing the sample liquid to the microfluidic channel, the only gas present in the microfluidic device is ambient air and, during the performance of the method, the distal gas and the separating gas consist of the ambient air that was present in the microfluidic device prior to introducing the sample liquid therein.

Embodiment 65: The method of any one of claims 34 to 64, wherein the microfluidic channel is a sample microfluidic channel, and the step of introducing the separating gas comprises introducing the separating gas through a separating gas microfluidic channel that intersects the sample microfluidic channel at the location occupied by the sample liquid.

Embodiment 66: The method of one of claims 34 to 65, wherein the step of oscillating comprises simultaneously oscillating the pressure of the distal gas and the separating gas.

Embodiment 67: The method of claim 66, wherein the step of oscillating comprises oscillating the pressure of the distal gas and the separating gas in phase with one another.

Embodiment 68: The method of claim 66, wherein the step of oscillating comprises oscillating the pressure of the distal gas and the separating gas out of phase with one another.

Embodiment 69: The method of any of claims 66 to 68, wherein the step of oscillating comprises oscillating the pressure of the distal gas and the separating gas at the same frequency and/or at different frequencies during at least a portion of the oscillating.

Embodiment 70: The method of any one of claims 34 to 69, wherein the step of introducing the separating gas to the microchannel displaces at least some of the liquid sample from a separating zone within the microfluidic channel and forms a separating gas bubble therewithin, the separating gas bubble disposed between the liquid segment and the remaining volume of the sample liquid.

Embodiment 71: The method of claim 70, wherein a volume of the separating gas bubble is at least about at least about 0.2 μL or more, at least about 0.3 L or more, at least about 0.4 μL or more, or at least about 0.5 μL or more.

Embodiment 72: The method of claim 70, wherein a volume of the separating gas bubble is about 5 μL or less, about 3.5μL or less, about 2.75 μL or less, about 1.75 μL or less, about 1.5 μL or less, about 1.25 μL or less, about 1 μL or less, about 0.75 μL or less, or about 0.5 μL or less.

Embodiment 73: The method of claim 71 or 72, wherein the volume of the separating gas bubble defines a volume of separating gas spacing apart the proximal gas-liquid interface of the liquid segment and a gas-liquid interface between the remaining volume of the sample liquid and the separating gas (“RSVL gas-liquid interface”).

Embodiment 74: The method of any one of claims 70 to 73, wherein the separating zone of the microfluidic channel tapers distally from a larger cross-sectional area to a smaller cross-sectional area.

Embodiment 75: The method of any one of claims 70 to 74, wherein the proximal gas-liquid interface occupies a portion of the microfluidic channel having a cross-sectional area A1, wherein the RVSL gas-liquid interface occupies a portion of the microchannel having a cross-sectional area A2, and wherein A2 is greater than Al such that the separating gas bubble comprises an asymmetrical shape.

Embodiment 76: The method of claim 75, wherein upon introduction of the separating gas into the microfluidic channel, a radius of curvature of the proximal gas-liquid interface is smaller than a radius of curvature of the RVSL gas-liquid interface, such that further introduction of the separating gas moves the RVSL gas-liquid interface proximally while leaving the proximal gas-liquid interface at or substantially at the same position, such that the liquid segment i) remains at or substantially the same position within the microfluidic channel, and/or ii) has the same or substantially the same amount of volume within the microfluidic channel.

Embodiment 77: The method of claim 76, wherein mixing the portion of the sample liquid with the at least one reagent comprises mixing the same or the substantially same amount of volume with the at least one reagent, thereby providing a determinative reagent concentration within the portion of the sample liquid.

Embodiment 78: The method of any one of claims 75 to 77, wherein a ratio of A2 to A1 (“R_{A}”) is at least about 1.25.

Embodiment 79: The method of any one of claims 75 to 78, wherein cross-sectional area A1 is between about 0.04 mm² and about 0.13mm².

Embodiment 80: The method of any one of claims 75 to 79, wherein a distance along a longitudinal axis of the microfluidic channel between the RSVL and proximal gas-liquid interfaces is between about 1 and 3 mm.

Embodiment 81: The method of any one of claims 74 to 80, wherein the cross-sectional area of the microfluidic channel between the RSVL and proximal gas-liquid interfaces decreases at an average rate of between about 12% mm⁻¹ and about 25% mm⁻¹.

Embodiment 82: The method of any one of claims 74 to 81, wherein a distance along the microfluidic channel between the RSVL gas-liquid interface and the location at which the separation gas is introduced into the microfluidic channel is a distance d1, wherein a distance along the microfluidic channel between the proximal gas-liquid interface and the location at which the separation gas is introduced into the microfluidic channel is a distance d2, and wherein a ratio d2/d1 is between about 2.25 and 10.

Embodiment 83: The method of any one of claims 74 to 82, wherein the proximal gas-liquid interface is disposed in the separation zone, and wherein the portion of the sample liquid of the liquid segment is substantially disposed in an analyzing zone of the microfluidic channel located distally to the separation zone, the analyzing zone having a cross-sectional area A3 that is larger than cross-sectional area A1.

Embodiment 84: The method of any one of claims 34 to 83, further comprising analyzing the portion of the sample liquid to detect a presence or absence of a target therein.

Embodiment 85: The method of any one of claims 34 to 84, wherein the at least one reagent comprises a binding reagent capable of specifically binding the target within the portion of the sample liquid, and wherein mixing the portion of the sample liquid with the at least one reagent enables binding of the binding reagent and the target to detect and/or determine an amount of binding reagent bound to the target.

Embodiment 86: The method of any one of claims 34 to 85, wherein, prior to introducing the sample liquid into the microfluidic channel, the at least one reagent is disposed within the microfluidic channel in a dry state.

Embodiment 87: The method of claim 86, wherein the at least one reagent is configured to solubilize with the sample liquid via contact therewith.

Embodiment 88: The method of any one of claims 34 to 87, wherein the microfluidic device further comprises one or more additional microfluidic channels, wherein each of the one or more additional microfluidic channels is configured to perform a method in any one of claims 35 to 87 so as to individually analyze the sample liquid.

Embodiment 89: The method of claim 88, wherein two or more of the microfluidic channel and the one or more additional microfluidic channels are configured to analyze the sample liquid simultaneously or in series.

Embodiment 90: The method of claim 88 or 89, wherein at least one of the one or more additional microfluidic channels comprises a respective separating gas chamber configured to i) introduce a respective separating gas to the respective additional microfluidic channel of the one or more additional microfluidic channels, and ii) oscillate a respective pressure of the respective separating gas.

Embodiment 91: The method of any one of claims 88 to 90, wherein at least one of the one or more additional microfluidic channels comprises a respective distal gas chamber configured to i) reduce a pressure of a respective distal gas to move a respective liquid segment distally along the respective additional microfluidic channel of the one or more additional microfluidic channels, and ii) oscillate the respective pressure of the respective distal gas.

Embodiment 92: A method, comprising: a) introducing a volume of a sample liquid into a microfluidic channel within a microfluidic device, the microfluidic channel containing a distal gas therein, such that the sample liquid contacts the distal gas, thereby forming a distal sample liquid-gas interface therebetween; b) introducing a separating gas into the microfluidic channel at a location occupied by the introduced volume of the sample liquid thereby separating a segment of the sample liquid from a remaining volume of the introduced volume of the sample liquid, the liquid segment comprising (i) the distal liquid-gas interface and (ii) a proximal gas-liquid interface, wherein the gas of the proximal gas liquid interface is the separating gas and the separating gas separates the proximal gas-liquid interface of the liquid segment from a liquid-gas interface of the remaining volume of the introduced volume of sample liquid; c) moving the liquid segment to a reagent zone of the microfluidic channel by decreasing a pressure of the distal gas, the reagent zone comprising at least one reagent disposed therein; and d) mixing the sample liquid of the liquid segment with the at least one reagent by oscillating the pressure of the distal gas and/or the pressure of the separating gas thereby forming a first mixture; wherein oscillating the pressure of the distal gas and/or separating gas is performed i) prior to, ii) concurrent with, and/or iii) after decreasing the pressure of the distal gas.

Embodiment 93: A method for detecting at least one target material in a sample liquid, the method comprising: a) introducing a volume of the sample liquid into a microfluidic channel within a microfluidic device, the microfluidic channel containing a distal gas therein, such that the sample liquid contacts the distal gas, thereby forming a distal sample liquid-gas interface therebetween; b) moving the sample liquid along the microfluidic channel until at least some of the sample liquid contacts at least one reagent disposed within a reagent zone of the microfluidic channel; c) introducing a separating gas into the microfluidic channel at a location occupied by the volume of the sample liquid thereby separating a segment of the sample liquid from a remaining volume of the introduced volume of the sample liquid, the liquid segment comprising (i) the distal liquid-gas interface, (ii) the sample liquid in contact with the at least one reagent, and (iii) a proximal gas-liquid interface, wherein the gas of the proximal gas liquid interface is the separating gas and the separating gas separates the proximal gas-liquid interface of the liquid segment from a liquid-gas interface of the remaining volume of the introduced volume of sample liquid; d) mixing the sample liquid of the liquid segment with the at least one reagent by oscillating the pressure of the distal gas and/or the pressure of the separating gas thereby forming a first mixture; wherein oscillating the pressure of the distal gas and/or separating gas is performed i) prior to, ii) concurrent with, and/or iii) after decreasing the pressure of the distal gas.

Embodiment 94: The method of any one of embodiments 92 to 93, wherein oscillating the pressure of the pressure of the distal gas and/or separating gas is performed at a frequency of about 2000 Hz or less, about 1500 Hz or less, about 1250 Hz or less, about 1000 Hz or less, about 900 Hz or less, about 800 Hz or less, from about 5 Hz to about 2500 Hz, or from about 10 Hz to about 2000 Hz.

Embodiment 95: The method of any one of embodiments 92 to 94, wherein the step of oscillating comprises oscillating the pressure of the distal gas and, during the step of oscillating, the distal liquid-gas interface occupies a location of the channel having a cross sectional area of at least about 0.01mm², at least about 0.02mm², at least about 0.03mm², at least about 0.04 mm², at least about 0.05mm², at least about 0.06mm², or at least about 0.07mm².

Embodiment 96: The method of any one of embodiments 92 to 95, wherein the step of oscillating comprises oscillating the pressure of the distal gas and, during the step of oscillating, the distal liquid-gas interface occupies a location of the channel having a cross sectional area of about 0.15 mm² or less, about 0.125 mm² or less, about 0.1 mm² or less, about 0.09 mm² or less, or about 0.08 mm² or less.

Embodiment 97: The method of any one of embodiments 92 to 96, wherein, during the step of oscillating, the liquid segment has a volume of at least about 0.2 μL or more, at least about 0.3 μL or more, at least about 0.4 μL or more, or at least about 0.5 μL or more.

Embodiment 98: The method of any one of embodiments 92 to 97, wherein, during the step of oscillating, the liquid segment has a volume of about 2 μL or less, about 1.75 μL or less, about 1.5 μL or less, about 1.25 μL or less, about 1 μL or less, about 0.75 μL or less, or about 0.5 μL or less.

Embodiment 99: The method of any one of embodiments 92 to 98, wherein the step of introducing the volume of sample liquid comprises moving the sample liquid by capillary action along the microfluidic channel until the distal sample liquid-gas interface contacts a capillary stop within the microfluidic channel.

Embodiment 100: The method of any one of embodiments 92 to 99, wherein the step of introducing the sample liquid comprises moving the sample liquid by capillary action along the microfluidic channel until the distal sample liquid-gas interface reaches and moves beyond the location at which the separating gas will be introduced.

Embodiment 101: The method of any one of embodiments 92 to 100, wherein the capillary stop comprises one or more vents providing gaseous communication between the microfluidic channel and a volume of gas disposed externally to the microfluidic channel.

Embodiment 102: The method of any one of embodiments 92 to 101, wherein the volume of gas is the ambient air surrounding the microfluidic device.

Embodiment 103: The method of any one of embodiments 92 to 102, wherein after introducing the volume of liquid sample into the microfluidic channel, the distal gas occupies a chamber of the microfluidic device that is isolated with respect to an ambient gas surrounding the microfluidic device.

Embodiment 104: The method of any one of embodiments 92 to 103, wherein, prior to introducing the volume of liquid sample into the microfluidic channel, the microfluidic channel provides the only route for gaseous communication between the distal gas and the exterior of the microfluidic device.

Embodiment 105: The method of any one of embodiments 92 to 104, wherein after introducing the volume of liquid sample into the microfluidic channel, the distal gas occupies a chamber of the microfluidic device that is isolated with respect to an ambient gas surrounding the microfluidic device.

Embodiment 106: The method of any one of embodiments 92 to 105, wherein, prior to introducing the volume of liquid sample into the microfluidic channel, the microfluidic channel and the one or more vent(s) provide the only route for gaseous communication between the distal gas and the exterior of the microfluidic device.

Embodiment 107: The method of any one of embodiments 92 to 106, wherein the ambient gas surrounding the microfluidic device is ambient air surrounding the microfluidic device.

Embodiment 108: The method of any one of embodiments 92 to 107, wherein the oscillating the pressure of the distal gas comprises oscillating the internal spacing between a first inner wall of a region of the microchannel occupied by the distal gas and a second inner wall of the region.

Embodiment 109: The method of any one of embodiments 92 to 108, wherein the region is a chamber of the microfluidic device and the first and second internal walls are internal walls of the chamber.

Embodiment 110: The method of any one of embodiments 92 to 109, wherein the oscillating the internal spacing between the first and second walls of the chamber comprises oscillating the internal spacing at a location of the chamber that is spaced apart along the microchannel from the distal liquid-gas interface.

Embodiment 111: The method of any one of embodiments 92 to 110, wherein the oscillating comprises contacting an outer wall of the chamber with an oscillating member.

Embodiment 112: The method of any one of embodiments 92 to 111, wherein the oscillating member contacts the outer wall of the chamber at a location spaced apart along the microchannel from the distal liquid-gas interface by a distance of at least about 5 mm, at least about 7.5 mm, at least about 10 mm, or at least about 15 mm.

Embodiment 113: The method of any one of embodiments 92 to 112, wherein after introducing the volume of liquid sample into the microfluidic channel, the separating gas occupies a chamber of the microfluidic device that is sealed with respect to an ambient gas surrounding the microfluidic device.

Embodiment 114: The method of any one of embodiments 92 to 113, wherein the ambient gas is air.

Embodiment 115: The method of any one of embodiments 92 to 116, wherein introducing the separating gas comprises heating the separating gas within the chamber occupied by the separating gas.

Embodiment 116: The method of any one of embodiments 92 to 115, wherein the step of introducing the separating gas comprises increasing the pressure of the separating gas and the method comprises decreasing a pressure of the distal gas during at least a portion of the step of increasing the pressure of the separating gas.

Embodiment 117: The method of any one of embodiments 92 to 116, wherein the method comprises operating the microfluidic device with an instrument and the method is performed without introducing any gas from a gas source of the instrument into the microfluidic channel.

Embodiment 118: The method of any one of embodiments 92 to 117, wherein, prior to introducing the sample liquid to the microfluidic channel, the only gas present in the microfluidic device is ambient air and, during the performance of the method, the distal gas and the separating gas consist of the ambient air that was present in the microfluidic device prior to introducing the sample liquid.

Embodiment 119: The method of any one of embodiments 92 to 118, wherein the microfluidic channel is a sample microfluidic channel and the step of introducing the separating gas comprises introducing the separating gas through a separating gas microfluidic channel that intersects the sample microfluidic channel at a location occupied by the sample liquid.

Embodiment 120: The method of any one of embodiments 92 to 119, wherein the step of oscillating comprises simultaneously oscillating the pressure of the distal gas and the separating gas.

Embodiment 121: The method of any one of embodiments 92 to 120, wherein the step of oscillating comprises oscillating the pressure of the distal gas and the separating gas in phase with one another.

Embodiment 122: The method of any one of embodiments 92 to 121, wherein the step of oscillating comprises oscillating the pressure of the distal gas and the separating gas out of phase with one another.

Embodiment 123: The method of any one of embodiments 92 to 122, wherein the step of oscillating comprises oscillating the pressure of the distal gas and the separating gas at the same frequency and/or at different frequencies during at least a portion of the oscillating.

Embodiment 124: The method of any one of embodiments 92 to 123, The method of any of the foregoing claims, wherein the step of introducing the separating gas to the microchannel displaces at least some of the liquid sample from a separating zone within the microchannel and the volume of the separating gas occupying the microchannel following the introduction is at least about at least about 0.2 L or more, at least about 0.3 μL or more, at least about 0.4 μL or more, or at least about 0.5 μL or more.

Embodiment 125: The method of any one of embodiments 92 to 124, wherein the step of introducing the separating gas to the microchannel displaces at least some of the liquid sample from a separating zone within the microchannel and the volume of the separating gas occupying the microchannel following the introduction is about 5 μL or less, about 3.5μL or less, about 2.75 μL or less, about 1.75 μL or less, about 1.5 μL or less, about 1.25 μL or less, about 1 μL or less, about 0.75 μL or less, or about 0.5 μL or less.

Embodiment 126: The method of any one of embodiments 92 to 125, wherein the volume of the separating gas occupying the microchannel following the introduction defines the volume of separating gas spacing apart the liquid-gas interface of the remaining volume of the introduced volume of sample liquid and the proximal gas-liquid interface of the liquid segment.

Embodiment 127: The method of any one of embodiments 92 to 126, wherein the at least one reagent comprises a binding reagent capable of specifically binding the target and the method further comprises binding the binding reagent and the target and detecting the amount of binding reagent bound to the target.

Embodiment 128: The method of any one of embodiments 92 to 127, wherein, prior to introducing the volume of sample liquid, the at least one reagent is disposed within the microchannel in a dry state.

Embodiment 129: A method, comprising: preparing a liquid segment in contact with and/or contains at least one reagent within a microchannel of a microfluidic device, wherein (i) the liquid segment defines a proximal gas-liquid interface and a distal liquid-gas interface, (ii) the gas of the proximal gas-liquid interface is a separating gas disposed between the liquid segment and a liquid-gas interface of an amount of liquid disposed within the microchannel proximally to the liquid segment, and (iii) the gas of the distal liquid-gas interface is a distal gas disposed within the microfluidic channel distally to the liquid segment; and mixing the liquid of the liquid segment with the reagent(s) by oscillating the pressure of the distal gas and/or the pressure of the separating gas thereby forming a first mixture.

Embodiment 130: The method of embodiment 129, wherein the amount of liquid disposed within the microchannel proximally to the liquid segment is a remaining amount of liquid remaining from a first amount of liquid and the method comprises, prior to the step of mixing, introducing the first amount of the liquid into the microchannel and separating the liquid segment from the remaining amount of liquid.

Embodiment 131: The method of any one of embodiments 129 to 130, wherein the step of separating the liquid segment from the remaining amount of liquid comprises introducing the separating gas into the microchannel through a separating gas microfluidic channel that intersects the microfluidic channel at a location occupied by the first amount of liquid.

Embodiment 132: The method of any one of embodiments 129 to 131, wherein the step of introducing the sample liquid comprises moving the first amount of liquid by capillary action along the microfluidic channel until at least some of the first amount of liquid reaches and moves beyond a location at which the separating gas microfluidic channel intersects the microfluidic channel.

Embodiment 133: The method of any one of embodiments 129 to 132, wherein the step of wherein the step of introducing the first amount of a liquid into the microchannel comprises moving the first amount of the liquid by capillary action along the microfluidic channel until a distal liquid-gas interface of the first amount of liquid contacts a capillary stop within the microfluidic channel.

Embodiment 134: The method of any one of embodiments 129 to 133, wherein the capillary stop comprises one or more vents providing gaseous communication between the microfluidic channel and a volume of gas disposed externally to the microfluidic channel.

Embodiment 135: The method of any one of embodiments 129 to 134, wherein the volume of gas disposed externally to the microfluidic channel is the ambient air surrounding the microfluidic device.

Embodiment 136: The method of any one of embodiments 129 to 135, wherein, prior to introducing the volume of liquid sample into the microfluidic channel, the microfluidic channel provides the only route for gaseous communication between the distal gas and the exterior of the microfluidic device.

Embodiment 137: The method of any one of embodiments 129 to 136, wherein after introducing the volume of liquid sample into the microfluidic channel, the distal gas occupies a chamber of the microfluidic device that is isolated with respect to an ambient gas surrounding the microfluidic device.

Embodiment 138: The method of any one of embodiments 129 to 137, wherein, prior to introducing the volume of liquid sample into the microfluidic channel, the microfluidic channel and the one or more vent(s) provide the only route for gaseous communication between the distal gas and the exterior of the microfluidic device.

Embodiment 139: A method, comprising: disposing a liquid in a microchannel of a microfluidic device; forming a gas bubble within the liquid in the microchannel thereby separating the liquid into first and second portions, wherein a first gas-liquid interface between the gas bubble and the first portion of the liquid occupies a portion of the microchannel having a cross-sectional area A1 and a second gas-liquid interface between the gas bubble and the second portion of the liquid occupies a portion of the microchannel having a cross-sectional area A2, a ratio A₂/A₁=R_{A} is at least about 1.25, e.g., is between about 1.5 and 3.5, e.g., is about 2.

Embodiment 140: The method of embodiment 139, wherein cross-sectional area A1 is between about 0.04 mm2 and about 0.13mm2, e.g., about 0.09mm², and the second cross-sectional area A₂ is equal to R_{A}×A₁.

Embodiment 141: The method of any one of embodiments 139 to 140, wherein a distance along a longitudinal axis of the microchannel between the first and second gas-liquid interfaces is between about 1 and 3 mm, e.g., is about 2 mm.

Embodiment 142: The method of any one of embodiments 139 to 141, wherein a volume of the gas bubble disposed within the microchannel between the first and second gas-liquid interfaces is between about 200 nL and about 750 nL, e.g., is about 350 nL.

Embodiment 143: The method of any one of embodiments 139 to 142, wherein, proceeding along a longitudinal axis of the microchannel from the location of the first gas-liquid interface to a location of the second gas-liquid interface, a cross-sectional area of the first microchannel tapers from a first area to a second, smaller area.

Embodiment 144: The method of any one of embodiments 139 to 143, wherein the cross-sectional area of the microchannel between the first and second gas-liquid interfaces decreases at an average rate of between about 12% mm⁻¹ and about 25% mm⁻¹, e.g., about 17.5% mm⁻¹.

Embodiment 145: The method of any one of embodiments 139 to 144, wherein the microchannel has an internal height h1 and an internal width w1 at a location of the microchannel occupied by the first gas-liquid interface wherein w1>h1.

Embodiment 146: The method of any one of embodiments 139 to 145, wherein the microchannel has an internal height h2 and an internal width w2 at a location occupied by the second gas-liquid interface wherein w2>w1>h2.

Embodiment 147: The method of any one of embodiments 139 to 146, wherein a ratio w2/w1 is about the same as the ratio RA of the second and first cross-sectional areas.

Embodiment 148: The method of any one of embodiments 139 to 147, wherein h1 and h2 are about the same, e.g., essentially identical, e.g., h1 and h2 may each be between about 50 μm and about 200 μm, e.g., about 110 μm.

Embodiment 149: The method of any one of embodiments 139 to 148, wherein w1 is between about 400 and 1200 μm, e.g., about 800 μm.

Embodiment 150: The method of any one of embodiments 139 to 149, wherein w2 is about RA×w1 μm.

Embodiment 151: The method of any one of embodiments 139 to 150, wherein w1 is about 800 μm and w2 is about 1600 μm.

Embodiment 152: The method of any one of embodiments 139 to 151, wherein the first portion of liquid comprises a distal gas-liquid interface disposed within the microchannel distally to the first gas-liquid interface.

Embodiment 153: The method of any one of embodiments 139 to 152, wherein the gas of the distal gas-liquid interface is enclosed within a distal portion of the microchannel of the microfluidic device.

Embodiment 154: The method of any one of embodiments 139 to 153, wherein the second portion of liquid comprises a proximal gas-liquid interface, wherein the gas of the gas-liquid interface is gas of the ambient atmosphere, e.g., air, surrounding the microfluidic device.

Embodiment 155: The method of any one of embodiments 139 to 154, wherein the microchannel is a first microchannel and the step of forming the gas bubble comprises introducing the gas of the gas bubble from a second microchannel that intersects the first microchannel at a gas-introduction opening occupied by the liquid.

Embodiment 156: The method of any one of embodiments 139 to 155, wherein a distance along the microchannel between the first gas-liquid interface and the gas-introduction opening is a distance d1, a distance along the microchannel between the second gas-liquid interface and the gas-introduction location is a distance d2, and a ratio d2/d1 is at least about 2.25, e.g., is between about 2.25 and 10, e.g., about 4.5.

Embodiment 157: The method of any one of embodiments 139 to 156, wherein disposing the liquid in the microchannel comprises, prior to forming the gas bubble, introducing the liquid to an application zone of the microchannel and flowing the liquid by capillary action along the microchannel until a distal gas-liquid interface of the liquid reaches a capillary stop located distally to the gas-introduction opening within the microchannel.

Embodiment 158: The method of any one of embodiments 139 to 157, wherein the flowing the liquid by capillary action comprises flowing the distal gas-liquid interface of the liquid along a distal portion of the microchannel disposed distally to the gas-introduction opening and wherein the distal portion of the microchannel has a width w3 that is greater than width w1.

Embodiment 159: The method of any one of embodiments 139 to 158, wherein a ratio w3/w1 is between about 2 and about 6, e.g., about 3.

Embodiment 160: The method of any one of embodiments 139 to 159, wherein the distal portion of the microchannel has a cross-sectional area A3, wherein a ratio A3/A1 is between about 2 and about 6, e.g., about 3.

Embodiment 161: The method of any one of embodiments 139 to 160, wherein the distal portion of the microchannel has a height h3, wherein h3, h2, and h1 are about the same, e.g., essentially identical, e.g., h3, h2, and h1 may each be between about 50 μm and about 200 μm, e.g., about 110 μm.

Embodiment 162: The method of any one of embodiments 139 to 161, wherein the step of forming the gas bubble comprises introducing an initial amount of the gas of the gas bubble into the microchannel through the gas introduction opening thereby forming an initial gas bubble having the first and second gas-liquid interfaces wherein the distance along the microchannel between the first gas-liquid interface of the initial gas bubble and the gas-introduction opening is a distance d1′, a distance along the microchannel between the second gas-liquid interface of the initial gas bubble and the gas-introduction location is a distance d2′, and a ratio d2′/d1′ is about 1.

Embodiment 163: The method of any one of embodiments 139 to 162, wherein the step of forming the gas bubble comprises introducing additional gas into the initial gas bubble through the gas introduction opening such that the distance along the microchannel between the second gas-liquid interface of the gas bubble and the gas-introduction opening increases relative to the distance along the microchannel between the first gas-liquid interface of the gas bubble and the gas-introduction opening until the distance along the microchannel between the second gas-liquid interface of the gas bubble and the gas-introduction opening is d2 and the distance along the microchannel between the first gas-liquid interface of the gas bubble and the gas-introduction opening is d1.

Embodiment 164: For any one of embodiments 1 to 163, wherein the liquid comprises a sample liquid obtained from a mammal, e.g., a human.

Embodiment 165: For any one of embodiments 1 to 164, wherein the sample liquid comprises blood, serum, plasma, saliva, urine, sputum, or material obtained from a swab such as a nasopharyngeal swab.

Embodiment 166: For any one of embodiments 1 to 165, wherein the liquid is a mixture comprising the sample liquid and an additional liquid such as a buffer.

Embodiment 167: For any one of embodiments 1 to 166, wherein liquid of the first portion of liquid comprises a reagent configured to facilitate the determination of one or more targets present in the first portion of the liquid.

Embodiment 168: For any one of embodiments 1 to 167, wherein a method includes contacting the liquid of the first portion of the liquid with the reagent after the step of forming the gas bubble.

Embodiment 169: For any one of embodiments 1 to 168, wherein a method includes contacting the liquid of the first portion of the liquid with the reagent before the step of forming the gas bubble.

Embodiment 170: For any one of embodiments 1 to 169, wherein a method includes contacting the liquid of the first portion of the liquid with an additional, different reagent after the step of forming the gas bubble.

Embodiment 171: For any one of embodiments 1 to 170, wherein the reagent contacted before the step of forming the gas bubble is a reagent configured to inhibit a coagulation of a blood sample, e.g., a heparin-comprising reagent.

Embodiment 172: For any one of embodiments 1 to 171, wherein the additional, different reagent comprises one or more reagents configured to bind a target.

Embodiment 173: For any one of embodiments 1 to 172, wherein the additional different reagents comprise one or more different particles comprising a binding agent for the target such as an antibody.

Embodiment 174: For any one of embodiments 1 to 173, wherein the particles comprise magnetic particles and fluorescent particles and the particles are configured to form a detectable sandwich with the target.

1. A microfluidic device, comprising:
a. a generally planar substrate comprising a microfluidic network therein, the microfluidic network comprising:
i. a distal gas chamber configured to adjust a pressure of a distal gas within at least a portion of the microfluidic network;
ii. a microfluidic channel extending distally from an application zone to the distal gas chamber, the application zone configured to receive a sample liquid therein; and
iii. a separation gas chamber in communication with the microfluidic channel via a separation gas channel that intersects the microfluidic channel at a separation gas introduction location, the separation gas chamber configured to adjust a pressure of a separation gas within at least a portion of the microfluidic network;
wherein, the sample liquid is configured to flow from the application zone through at least a portion of the microfluidic channel to a capillary stop located distal to the separation gas introduction location, such that introduction of the separation gas into the microfluidic channel thereafter forms a separation gas bubble within the microfluidic channel that separates the sample liquid therein into i) a liquid segment located distal to the separation gas bubble, and ii) a remaining volume of sample liquid located proximal to the separation gas bubble, the liquid segment forming i) a distal gas-liquid interface disposed between the distal gas and the liquid segment, and ii) a proximal gas-liquid interface disposed between the separating gas and the liquid segment.

2. The microfluidic device of claim 1, wherein the microfluidic channel comprises a reagent zone distal to the separation gas introduction location and configured to comprise one or more reagents.

3.-4. (canceled)

5. The microfluidic device of claim 2, wherein the microfluidic channel comprises a detection zone distal to the reagent zone and configured to detect a presence or absence of the target within the sample liquid.

6. (canceled)

7. The microfluidic device of claim 3, wherein the distal gas chamber comprises a first inner wall and a second inner wall defining a distal chamber spacing therebetween and an outer wall of the distal gas chamber is configured to be contacted with an oscillating member so as to oscillate and/or adjust the distal chamber spacing, thereby oscillating and/or adjusting the pressure of the distal gas.

8. The microfluidic device of claim 7 4, wherein adjusting the pressure of the distal gas facilitates movement of the liquid segment within the microfluidic channel.

9.-11. (canceled)

12. The microfluidic device of claim 5, wherein an outer wall of the separation gas chamber is configured to be contacted with a second oscillating member so as to oscillate and/or adjust the separation gas chamber spacing, thereby oscillating and/or adjusting the pressure of the separation gas.

13. The microfluidic device of claim 1, wherein the separating gas bubble defines a volume of separating gas disposed between the proximal gas-liquid interface and a gas-liquid interface between the remaining volume of the sample liquid and the separating gas bubble (RVSL gas-liquid interface), the separation gas bubble disposed within a separation zone of the microfluidic channel.

14. The microfluidic device of claim 7, wherein the separating zone of the microfluidic channel tapers distally from a larger cross-sectional area to a smaller cross-sectional area.

15. The microfluidic device of claim 7, wherein the proximal gas-liquid interface occupies a portion of the microfluidic channel having a cross-sectional area A1, wherein the RVSL gas-liquid interface occupies a portion of the microchannel having a cross-sectional area A2, and wherein A2 is greater than A1 such that the separating gas bubble comprises an asymmetrical shape.

16. The microfluidic device of claim 9, wherein upon introduction of the separating gas into the microfluidic channel, a radius of curvature of the proximal gas-liquid interface is smaller than a radius of curvature of the RVSL gas-liquid interface, such that further introduction of the separating gas moves the RVSL gas-liquid interface proximally while leaving the proximal gas-liquid interface at or substantially at the same position within the microfluidic channel, such that the liquid segment i) remains at or substantially the same position within the microfluidic channel, and/or ii) has the same or substantially the same amount of volume within the microfluidic channel.

17.-18. (canceled)

19. The microfluidic device of claim 7, wherein a distance along a longitudinal axis of the microfluidic channel between the RSVL and proximal gas-liquid interfaces is between about 1 and 3 mm.

20. The microfluidic device of claim 7, wherein the cross-sectional area of the microfluidic channel between the RSVL and proximal gas-liquid interfaces decreases at an average rate of between about 12% mm⁻¹ and about 25% mm⁻¹.

21. The microfluidic device of claim 7, wherein a distance along the microfluidic channel between the RSVL gas-liquid interface and the separation gas introduction location is a distance d1, wherein a distance along the microfluidic channel between the proximal gas-liquid interface and the separation gas introduction location is a distance d2, and wherein a ratio d2/d1 is between about 2.25 and 10.

22. (canceled)

23. The microfluidic device claim 1, wherein the generally planar substrate comprises an upper layer, a lower layer, and a middle layer disposed between the upper and lower layers.

24.-91. (canceled)
